(19) United States
(12) Patent Application Publication
(10) Pub. No.: US 2006/0231484 A1
(43) Pub. Date: Oct. 19, 2006

(54) Composites and composite membranes

(76) Inventors: Thomas Haring, Stuttgart (DE); Vladimir Linkov, Somerset West (ZA); Jochen Kerres, Ostfildern (DE); Andreas Ullrich, Esslingen (DE); Chy-Ming Tang, Weinheim (DE); Martin Hein, Stuttgart (DE); Wei Zhang, Stuttgart (DE)

Correspondence Address: FITCH EVEN TABIN AND FLANNERY, 120 SOUTH LA SALLE STREET, SUITE 1600, CHICAGO, IL, 60603-3406, US

(21) Appl. No.: 10/929,648

(22) Filed: Aug. 30, 2004

Related U.S. Application Data
(63) Continuation of application No. PCT/DE03/00640, filed on Feb. 21, 2003.

(30) Foreign Application Priority Data
Feb. 28, 2002 (DE) 102 09 774.7

(51) Int. Cl. B01D 71/06

(52) U.S. Cl. 210/500.27; 521/27; 210/500.36; 210/500.21

(57) ABSTRACT

The invention relates to the following types of composite membranes; composites or composite membranes obtained by adding a metal salt, e.g. from ZrOCl₂, to a solvent, especially DMSO, for dissolving one or more polymers in an organic solvent or in aqueous systems, in addition to the subsequent precipitation in the matrix of the thus produced composite-membrane by post-treatment thereof in an acid or in a salt solution, especially phosphoric acid. The invention also relates to composites or composite membranes obtained by subsequent ion exchange of finished polymer membranes with a suitable salt cation, especially ZrO₂⁺, wherein the polymer membrane is, optionally, swollen with an organic solvent or a mixture of organic solvent with water prior to the ion exchange and the subsequent precipitation of a low soluble salt, e.g. from Zr₃ (PO₄)₄, in the membrane by post-treatment thereof in an acid or in a salt solution, especially phosphoric acid. The invention further relates to composites or composite membranes obtained by adding nano-scaled Zr₃(PO₄)₄ powder to a polymer solution, composites and composite membranes obtained according to the above-mentioned methods, wherein additional heteropoly acids are also incorporated into the polymer or membrane morphology, in addition to methods for producing said inventive polymers and membranes.

### SUMMARY

Claimed are the following types of composite membranes:

1. Composites or composite membranes by addition of a metal salt, e.g. ZrOCl₂, in a solvent, e.g. DMSO, to a solution of one or more polymers in an organic solvent or in aqueous systems as well as the subsequent precipitation in the matrix of the hence produced composite membrane by post-treatment in an acid or in a salt solution, e.g. phosphoric acid.

2. Composites or composite membranes by subsequent ion exchange of finished polymer membranes with a suitable salt cation, e.g. ZrO₂⁺, whereas the polymer membrane if necessary is swollen prior to ion exchange with an organic solvent or a mixture of organic solvent with water as well as the subsequent precipitation of a sparingly soluble salt, e.g. of Zr₃(PO₄)₄, in the membrane by post-treatment in an acid or in a salt solution, e.g. phosphoric acid.

3. Composites or composite membranes by addition of nano-size Zr₃(PO₄)₄-powder to a polymer solution.

4. Claimed are also composites or composite membranes, which are produced as in 1. and/or 2. and/or 3, whereas additionally hetero polyacids are incorporated into the polymermorphologie or the membranemorphologie.

Claimed are also processes to produce polymers and membranes according to the invention.

### STATE-OF-THE-ART

Composite membranes from organic polymers and inorganic fillers have been described often, and in fact in journals as well as in patents. A patent example, which contains also many hints to other developments in composite membrane s, is a U.S. patent of Lynntech, Inc.¹. In this patent however no composite membranes are described, whose organic phase is ionically and/or covalently cross-linked, as is the case in the present invention. In² composite membranes from Nafion® and zirconiumphosphate are described, where the zirconiumphosphate has been incorporated subsequently into the membrane by 1) ion exchange H⁺ against Zro²⁺ in the Naflon®-membrane, 2) Soaking of the ionexchanged Nafion®-membrane in phosphoric acid and precipitation of ZrO²⁺-ions in the membrane matrix as Zr-phosphates. Disadvantage of the method is however that only as much Zr-phosphate can be precipitated in the membrane, as are SO₃H-groups in the Nafion®-matrix. Also own developments in this field have been filed as patent: first composite-membranes from organic polymers and organic polymer blends containing cation exchange groups and/or basic groups alternatively non ionic precursors of cation exchange groups, whereas acid-base-blends are preferred, and inorganic compounds, whereas the inorganic compounds are incorporated in the membrane matrix as organometalic compounds (such as e.g. metal acetylacetonates, metal alkoxides) and are hydrolysed in the membrane matrix to the respective metaloxide or metalhydroxide^{3,4}. The materials according to the invention respectively processes to produce the polymers and membranes according to the invention as described in this invention have not been described in the above mentioned own patent applications. A further group of composite membranes are composites from sulfonated poly(etherketones) and the hetero polyacids phosphoric tungsten acid hydrate H₃PW₁₂O₄₀x29 H₂O (TPA) and molybdatophosphoric acid hydrate H₃PMo₁₂O₄₀x29 H₂O (MPA) as well as the disodium salt of TPA (Na-TPA)⁵. In this publication no ionically and/or covalently cross-linked ionomer membranes have been described as is the case in the present invention.
¹ U.S. Pat. No. 6,059,943, O. J. Murphy, A. J. Cisar, Lynntech, Inc. (2000)

²C. Yang, et al., Electrochem. Solid St. Lett. 4(4) A31-A34 (2001)

³ Jochen Kerres, German patent application 10021106 from 2.5.2000

⁴ Jochen Kerres, Thomas Häring, German patent application 10021104 from 2.5.2000

⁵S. M. J. Zaidi, S. D. Mikhailenko, G. P. Robertson, M. D. Guiver, S. Kaliaguine, J. Memb. Sci. 173, 17-34 (2000)

### DESCRIPTION

It has been found surprisingly, that composites oder composite membranes made from polymer metal salt or polymer metal oxide or polymer metal hydroxide can be produced with the following method method 1 in the most general embodiment:
I.1. Making of a solution of one or more polymers of the type A (polymer with cation exchange groups or their non-ionic precursors) and if necessary one or more polymers of the type B (polymers with N-basic groups and/or anion exchange groups) and if necessary of type C (polymers with cross-linking groups such as sulfinate groups and/or unsaturated groups) and/or polymers of the type D (polymers with cation exchange groups or their non-ionic precursors and anion exchange groups and/or basic N-groups and/or cross-linking groups) in a solvent L1 and if necessary a if necessary nano-sized metal oxide powder, metal salt powder or metal hydroxide powder (8);
I.2. Making of a solution of one or more metal salts Me⁺X⁻ (10) in a suitable solvent L2 (11), if necessary by addition of a (hetero)polyacid or their alkali metal salt (9);
I.3. Mixing of solutions from 1. and 2;
I.4. Casting or spraying of a thin film of the mixture of 3. on a support (foil or textile or nonwoven or glass plate or metal plate);
I.5. Evaporation of the solvents L1 and L2 at elevated temperature and if necessary reduced pressure;
I.6. Separation of the composite film from the support;
I.7. Soaking of the composite film in the following liquids:
   I.7a aqueous solution of a basic metal hydroxide MOH or an amine or ammonia N(R₂)₃ at temperatures from 0° C. to 100° C., at which precipitation of a sparingly soluble metal oxide MeₘOₙ or metal hydroxide Meₘ(OH)ₙ or mixed metal oxide-hydroxide MeₘOₙ*xH₂O in the membrane matrix takes place;
   I.7b aqueous solution of an inorganic acid HY at temperatures from 0 CC to 100° C., which precipitates a sparingly soluble metal salt MeₘYₙ in the membrane matrix;
   I.7c water at temperatures from 0° C. to 100° C.,
   I.7d aqueous solution of a metal salt MY at temperatures from 0° C. to 100° C., which precipitates a sparingly soluble metal salt MeₘYₙ by Ion exchange in the membrane matrix.

Furthermore it has been found surprisingly, that composites or composite membranes made from polymer metal salt or polymer metal oxide or polymer metal hydroxide can be produced with the following method method II in the most general embodiment:
II.1. Making of a solution of one or more polymers of the type A (polymer with cation exchange groups or their nonionic precursors) and if necessary one or more polymers of the type B (polymers with N-basic groups and/or anion exchange groups) and if necessary of type C (polymers with cross-linking groups such as sulfinate groups and/or unsaturated groups) and/or polymers of the type D (polymers with cation exchange groups or their nonionic precursors and anion exchange groups and/or basic N-groups and/or cross-linking groups) and if necessary addition of a cross-linker (e.g. Alkylation cross-linker (e.g. α,ω-dihalogenalkane)) or radical starter in a solvent L1 and if necessary a if necessary nano-sized metal oxide powder, metal salt powder or metal hydroxide powder and/or a (hetero)polyacid;
II.2. Casting or spraying of a thin film of the mixture of 1. on a support (foil or textile or nonwoven or glass plate or metal plate);
II.3. Evaporation of the solvent L1 at elevated temperature and if necessary reduced pressure; during the solvent evaporation takes place if necessary the cross-linking of the cross-linker;
II.4. Separation of the composite film from the support;
II.5. Soaking of the composite film in the following liquids:
   II.5a water or mixture of water with organic solvent L1 at temperatures from 0° C. to 100° C.;
   II.5b aqueous solution or solution of one or more metal salts Me⁺X⁻ or solution of one or more metal salts Me⁺X⁻ in a mixture of water and organic solvent L2 at temperatures from 0° C. to 100° C.; in doing so ion exchange takes place:
      Polymer-R⁻C⁺+Me⁺ X⁻→Polymer-R⁻Me⁺+C⁺X⁻
      Me⁺ represents any 1- to 4-valent metal cation or metal oxycation, X⁻ represents any ^{a}nion, R⁻ represents any Polymer-fixed-anion, C⁺ represents any counter ion (any cation)
   II.5c water at temperatures from 0° C. to 100° C.;
   II.5d aqueous solution of a basic metal hydroxide MOH at temperatures from 0° C. to 100° C., at which precipitation of a sparingly soluble metal oxide MeₘOₙ or metal hydroxide Meₘ(OH)ₙ in the membrane matrix takes place;
   II.5e water at temperatures from 0° C. to 100° C.;
   II.5f aqueous solution of an inorganic acid HY at temperatures from 0° C. to 100° C., which precipitates a sparingly soluble metal salt MeₘYₙ in the membrane matrix;
   II.5g aqueous solution of a metal salt MY at temperatures from 0° C. to 100° C., which precipitates a sparingly soluble metal salt MeₘYₙ by ion exchange in the membrane matrix,
   II.5h water at temperatures from 0° C. to 100° C.;
   II.5i one-time or several times repetition of the procedure 5a to 5h.

Thereby it has been found surprisingly, that the production processes Method I and Method II can be combined as follows:

First the composite film is produced according to Method I. Then the process is carried out according to methode II starting from II.5. Thereby multinary composite films are formed, which due to the incorporation of inorganic components into the various areas of the polymermorphologie show very good mechanical and thermal stability as well as very good ion conductivity and in use in direct methanol fuel cells also very good methanol retention. The advantages of the composite membranes produced according to Method I or Method II or a combination of Method I with Method II are:
the by ion exchange precipitation in the polymer matrix incorporated if necessary self-proton conducting inorganic substances according to Method II, II.5 are mainly incorporated in the ion conducting channels. There they increase the proton conductivity of the membrane also at temperatures >100° C., because the inorganic substances especially at temperatures >100° C. increase the water retention capacity of the composite membrane and show also in part a self proton conductivity (such as e.g. heteropolyacids, vanadineoxide, zirconiumphosphate);
the composite membranes produced according to Method I or Method II or a combination of Method I with Method II show great mechanical stability, because the network of the inorganic component(s) reaches out over the entire morphology. Furthermore the inorganic components increase the thermal stability of the composite membranes substantially;
the composite membranes exhibit due to the inorganic components in the membrane matrix a very low methanol cross-over, which increases the efficiency of the membranes if used in direct methanol fuel cells (DMFC) considerably, whereby the efficiency is increased especially at temperatures >100° C. by the inorganic component(s) due to their good water retention capacity. If a DMFC is run at temperatures >100° C., the efficiency is increased also by the faster electrode kinetic in this temperature range (middle temperature-DMFC). The MeOH-retention is especially pronounced for composite membranes according to the invention, where the inorganic compound is incorporated into the ion-conducting channels (such as e.g. for II.5). The MeOH-retention of composite membranes produced according to II.5 can be surprisingly further increased, if the ion exchange precipitation process is repeated several times.
It has been found surprisingly, that soaking of a membrane in a mixture of water and organic solvent (II.5.a) before the ion exchange precipitation process leads to a proportional increase of the ion conductivity of the membrane compared to the proportion of the organic solvent in the solvent/water mixture.
It has been found surprisingly, that heteropolyacids in the membrane matrix are better retained, if a sparingly soluble inorganic phase is present in the composite membrane. If no inorganic phase is present in the membrane, the hetero polyacids are rinsed out for the greater part during the post-treatment step in water, acids and/or aqueous base.
It has been complementary detected, that especially oxide- or salt-polymer-composite(blend)membranes, which contain ionical cross-linking places in the organopolymercomponent, exhibit a very high MeOH-retention, as compared to the corresponding pure organopolymer(blend)membranes.
It has been found surprisingly, that in the polymerphase covalently and/or ionically cross-linked oxide- or salt-polymer-composite(blend)membranes show a especially good swelling stability also at temperatures >70° C., as compared to the corresponding pure organopolymer(blend)membranes.
If polymer mixtures according to the invention, e.g. a sulfonated polymer (e.g. sulfonated PEK in the imidazole ion salt form SO₃⁻ImH⁺) and a basic polymer (e.g. polybenzimidazole PBI Celazol®), are mixed in a dipolar-aprotic solvent, e.g. N-methylpyrrolidinone, in addition with heteropolyacids, surprisingly there is no significant precipitation of polyelectrolyte complexes of basic polymer and heteropolyacid, as it could be expected.

The components of the composite membranes according to the invention are defined as follows:

(1) Main Chains (Backbones) of Polymers According to the Invention:

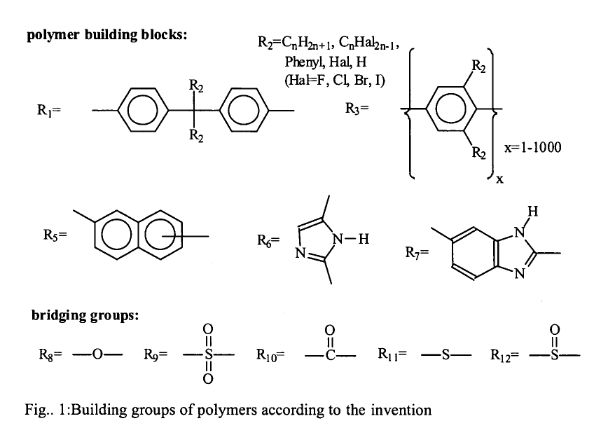

As polymer main chains all polymers are possible. Preferred as main chains are however:
polyolefines such as polyethylene, polypropylene, polyisobutylene, polynorbornene, polymethylpentene, poly(1,4-isoprene), poly(3,4-isoprene), poly(1,4-butathene), poly(1,2-butathene)
styrol(co)polymers such as polystyrole, poly(methylstyrol), poly(α,β,β-trifluorstyrol), poly(pentafluorostyrol)
perfluorinated ionomeres such as Nafion® or the SO₂Hal-precursor of Nafion® (Hal represents F, Cl, Br, I), Dow®-Membrane, GoreSelect®-Membrane.
N-basic polymers such as polyvinylcarbazole, polyethylenimine, poly(2-vinylpyridine), poly(3-vinylpyridine), poly(4-vinylpyridine)
(Het)arylmain chain polymers containing the construction units from FIG. 1.

Especially preferred are (Het)arylmain chain polymers such as:
polyetherketone such as polyetherketone PEK Victrex®, polyetheretherketone PEEK Victrex®, polyetheretherketoneketone PEEKK, polyetherketonether-ketoneketone PEKEKK Ultrapek®
polyethersulfones such as Polysulfon Udel®, Polyphenylsulfon Radel R®, polyetherethersulfones Radel A®, polyethersulfone PES Victrex®
poly(benz)imidazole such as PBI Celazol® and other oligomers and polymers containing the (benz)imidazole-unit, in which the (benz)imidazole group can be present in the main chain or in the side chain
polyphenylenether such as poly(2,6-dimethyloxyphenylen), poly(2,6-diphenyloxyphenylen)
polyphenylensulfide and copolymers
poly(1,4-phenylene) or poly(1,3-phenylene), which can be modified in the side chain with benzoyl, naphtoyl- or o-phenyloxy-1,4-benzoylgroups, m1-phenyloxy-, 1,4-benzoylgroups or p-phenyloxy-1,4-benzoylgroups,
poly(benzoxazole) and copolymers
poly(benzthiazole) and copolymers
poly(phtalazinone) and copolymers
polyaniline and copolymers
polythiazoles
polypyrroles
   (2) Polymers of typ A (Polymers with Cation Exchange Groups or their Non-Ionic Precursors):

Polymertyp A comprises all polymers, composed from the above mentioned Polymermain chains (1) and the following cation exchange groups or their non ionic precursors:

SO₃H, SO₃Me; PO₃H₂, PO₃Me₂; COOH, COOMe

SO₂X, POX₂, COX with X represents Hal, OR₂, N(R₂)₂, anhydride radical, N-imidazolee radical 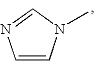
N-pyrazole radical 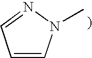
1. Preferred as functional groups are SO₃H, SO₃Me; PO₃H₂, PO₃Me₂ respectively SO₂X, POX₂. Especially preferred as functional groups are the strong acidic sulfonic acid groups or their non-ionic precursors. As polymermain chains preferred are aryl main chain polymers. Especially preferred are poly(etherketones) and poly(ethersulfones).
   (3) Polymers of typ B (Polymere with N-Basic Groups and/or Anion Exchange Groups):

Polymertyp B comprises all polymers, composed from the above mentioned (1) and from the following anion exchange groups or their non-ionic precursor (with primary, secondary or tertiary basic N):

N(R₂)₃⁺Y⁻, P(R₂)₃⁺Y⁻, whereat R₂ radicals can be the same or different from each other;

N(R₂)₂ (primary, secondary or tertiary amines);

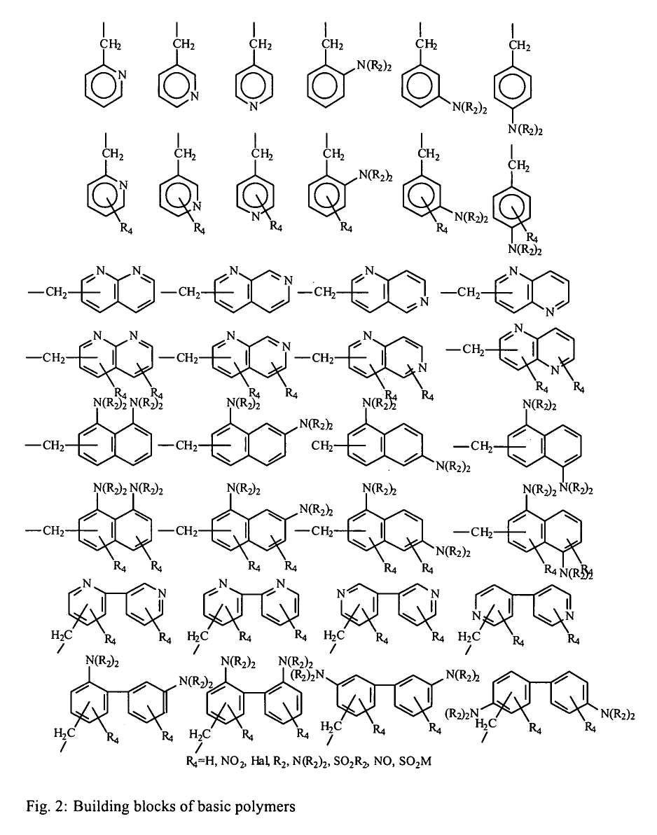

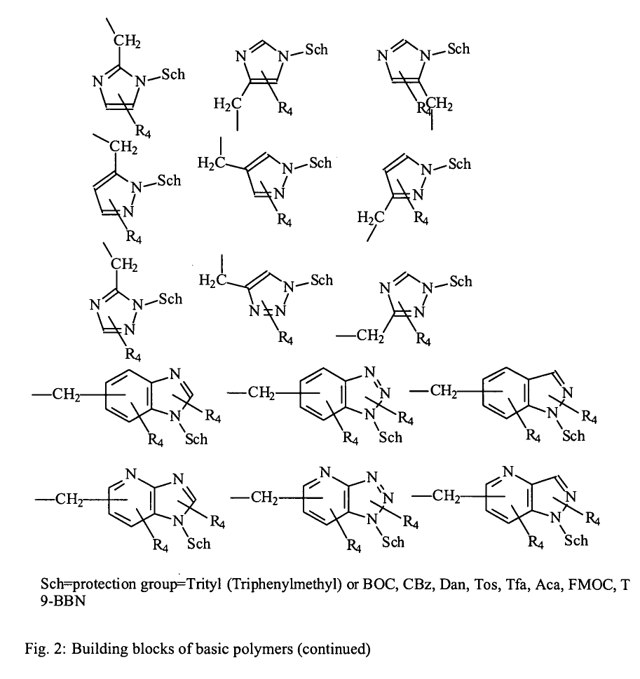

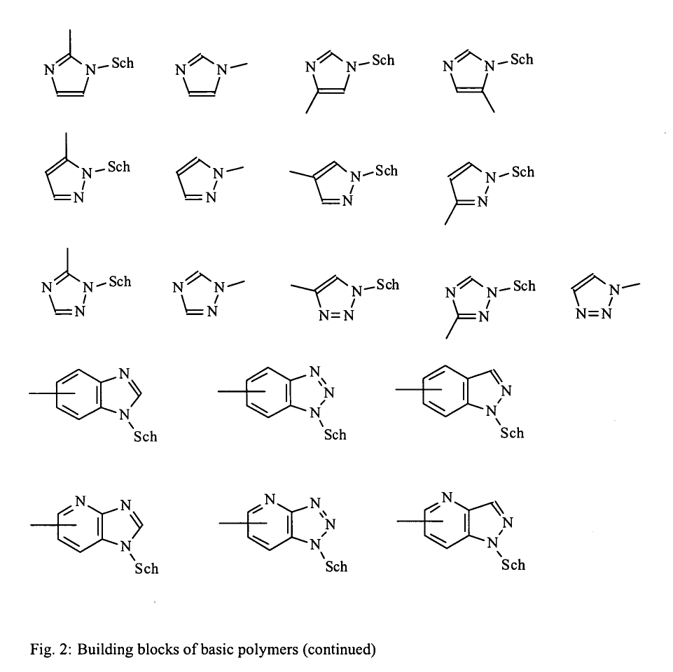

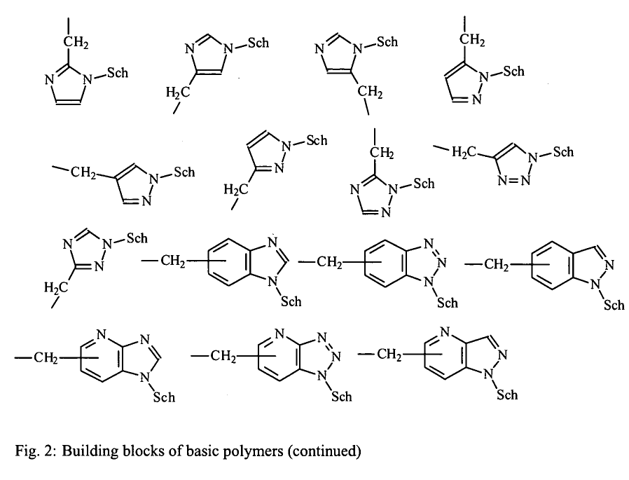

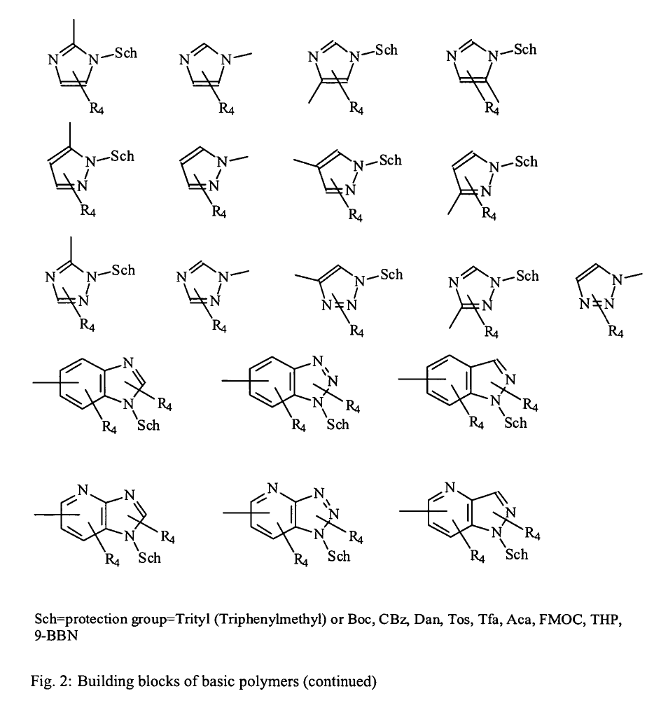

Polymere with N-basic (Het)aryl- and Heterocyclic groups as in FIG. 2.

As polymer main chains preferred are (Het)aryl main chain polymers such as poly(etherketones), poly(ethersulfones) and poly(benzimidazolee). As basic groups preferred are primary, secondary and tertiary amino groups, pyridyl groups and imidazolee groups.

(4) Polymers of typs C (Polymers with Cross-Linking Groups Such as Sulfinate Groups and/or Unsaturated Groups):

Polymertyp C comprises all polymers composed from the above mentioned polymer main chains (1) and cross-linking groups. Cross-linking groups are e.g.:

4a) alkene groups: polymer-C(R₁₃)═C(R₁₄R₁₅) with R₁₃, R₁₄, R₁₅═R₂ or R₄

4b) polymer-Si(R₁₆R₁₇)—H with R₁₆, R₁₇═R₂ or R₄

4c) polymer-COX, polymer-SO₂X, polymer-POX₂

4d) sulfinate groups polymer-SO₂Me

4e) polymer-N(R₂)₂ with R₂≠H

Thereby one or more of the mentioned cross-linking groups can be present on the polymer main chain. The cross-linking can be carried out according to the following reactions known from the literature:
(I) group 4a) by addition of peroxides;
(II) group 4a) with group 4b) by Pt-catalysis via hydrosilylation;
(III) group 4d) with dihalogenalkane- or dihalogenaryl cross-linking agents (e.g. Hay (CH₂)ₓ-Hal, x represents a number between 3 and 20) by S-alkylation of the sulfinate group;
(IV) group 4e) with dihalogenalkane- or dihalogenaryl cross-linking agents (e.g. Hal-(CH₂)ₓ-Hal, x represents a number between 3 and 20) by alkylation of the tertiary basic N-group
(V) group 4d) and group 4e) with dihalogenalkane- or dihalogenaryl cross-linking agents (e.g. Hal-(CH₂)ₓ-Hal, x represents a number between 3 and 20) by S-alkylation of the sulfinate group and alkylation of the tertiary basic N-group
(VI) group 4c) by reaction with diamines.

Thereby the cross-linking reactions (III), (IV) and (V) are preferred, especially the cross-linking reaction (III).

(5) Polymers of typ D (Polymers with Cation Exchange Groups and Anion Exchange Groups and/or Basic N-Groups and/or Cross-Linking Groups):

Polymertyp D comprises all polymers carrying the main chains from (1), which can carry different groups: cation exchange groups or their nonionic precursors as in (2) and anion exchange groups or primary, secondary or tertiary N-basic groups as in (3) and/or the cross-linking groups as in (4).

The following combinations are possible:
Polymer D1: polymer with cation exchange groups or their non ionic precursors and with anion exchange groups or with N-basic groups
Polymer D2: polymer with cation exchange groups or their non-ionic precursors and with cross-linking groups
Polymer D3: polymer with anion exchange groups and with cross-linking groups
Polymer D4: polymer with cation exchange groups or their non-ionic precursors and with anion exchange groups and with cross-linking groups
   (6) Typs of Membranes:
   (6.1) Covalently Cross-Linked (Blend)Membranes:

The covalently cross-linked (blend)membranes can consist of the following components:
(6.1.1) blend membranes from:
(6.1.1.1) polymer A: main chain (1) with cation exchange groups (2)
   +polymer C: main chain (1) with cross-linking groups (4)
   +cross-linking agent or cross-linking starter
or
(6.1.1.2) polymer D2: main chain (1) with cation exchange groups (2) and cross-linking groups (4)
   +Polymer C: main chain (1) with cross-linking groups (4)
   +cross-linking agent or cross-linking starter
(6.1.2) Polymer D2: main chain (1) with cation exchange groups (2) and cross-linking groups (4)
   +cross-linking agent or cross-linking starter

As main chains (1) aryl main chain polymers are preferred and especially poly(etherketones) or poly(ethersulfones), as cation exchange groups (2) SO₃H-groups or phosphonic acid groups or their non-ionic precursors, and as cross-linking groups (4) SO₂Me-groups. As cross-linking agents dihalogenalkane- or dihalogenaryl compounds are preferred. Especially preferred as cross-linking agents are Hal-(CH₂)ₓ-Hal, x represents a number between 3 and 20, with Hal═I, Br, Cl, F.

(6.2) Ionically Cross-Linked (Blend)Membranes:

The ionically cross-linked (blend)membranes can consist of the following components:
(6.2.1) blend membranes from:
(6.2.1.1) polymer A: main chain (1) with cation exchange groups (2)
   +polymer B: main chain (1) with anion exchange groups or with N-basic groups (3)
oder
(6.2.1.2) polymer D1: main chain (1) with cation exchange groups (2) and anion exchange groups or with N-basic groups (3)
   +polymer B: main chain (I) with anion exchange groups or with N-basic groups (3)
(6.1.2) polymer D1: main chain (1) with cation exchange groups (2) and anion exchange groups or with N-basic groups (3)

As main chain (1) aryl main chain polymers are preferred and especially poly(etherketones) or poly(ethersulfones), as cation exchange groups (2) SO₃H-groups or phosphonic acid groups or their non-ionic precursors.

(6.3) Covalent-Ionically Cross-Linked (Blend)Membranes:

The covalently-ionically cross-linked (blend)membranes can consist of the following components:
(6.3.1) blend membranes from:
(6.3.1.1) polymer A: main chains (1) with cation exchange groups (2)
   +polymer C: main chains (1) with cross-linking groups (4)
   +polymer B: main chains (1) with anion exchange groups or with N-basic groups (3)
   +cross-linking agent or cross-linking starter
or
(6.3.1.2) polymer D2: main chains (1) with cation exchange groups (2) and cross-linking groups (4)
   +polymer B: main chains (1) with anion exchange groups or with N-basic groups (3)
   +cross-linking agent or cross-linking starter
or
(6.3.1.3) polymer D1: main chains (1) with cation exchange groups (2) and anion exchange groups or with N-basic groups (3)
   +polymer C: main chains (1) with cross-linking groups (4)
   +cross-linking agent or cross-linking starter
or
(6.3.1.4) polymer A: main chains (1) with cation exchange groups (2)
   +polymer B: main chains (1) with anion exchange groups or with N-basic groups (3)
   +cross-linking agent or cross-linking starter
(6.3.2) polymer D4: membranes from main chains (1) with cation exchange groups (2) and anion exchange groups or with N-basic groups (3) and cross-linking groups (4)
   +cross-linking agent or cross-linking starter

As main chains (1) aryl main chain polymers are preferred and especially poly(etherketones) or poly(ethersulfones), as cation exchange groups (2) SO₃H-groups or phosphonic acid groups or their non-ionic precursors, and as cross-linking groups (4) SO₂Me-groups. As cross-linking agents dihalogenalkane- or dihalogenaryl compounds are preferred. Especially preferred as cross-linking agents are Hal-(CH₂)ₓ-Hal, x represents a number between 3 and 20, with Hal═I, Br, Cl, F.

(7) Solvent L1:

(7.1) Protic Solvents:

Water, alcoholes (e.g. methanol, ethanol, n-propanol, i-propanol, tert. butanol); aqueous and/or alcoholic metal salt solutions, aqueous and/or alcoholic lowmolecular polymer solutions conataining cation exchange groups;

(7.2) Dipolar-Aprotic Solvents:

acetone, methylethylketone (MEK), acetonitrile (ACN), N-methylformamide, N,N-dimethylformamide (DMF), N-methylacetamide, N,N-dimethylacetamide (DMAc), N-methylpyrrolidinone (NMP), dimethylsulfoxide (DMSO), sulfolane;

(7.3) Ether Solvents:

tetrahydrofurane, oxane, dioxane, glyme, diglyme, triglyme, tetraglyme, diethylether, di-tert. Butylether.

(8) Metal Oxide Powder, Metal Salt Powder or Metal Hydroxide Powder, Especially Preferred are Nano-Sized Powder:

Phyllosilicate based on montmorillonite, smectite, illite, sepiolite, palygorskite, muscovite, allevardite, amesite, hectorite, talc, fluorhectorite, saponite, beidelite, nontronite, stevensite, bentonite, mica, vermiculite, fluorvermiculite, halloysite, fluor containing synthetical talc types or blends of two or more of the above-mentioned phyllosilicates.
Natural and synthetical, if necessary ion exchanged zeolithes, especially ZSM-5 zeolith and klinopthiolites
Addionally the carbonates are suitable such as e.g. MgCO₃xH₂O and La(CO₃)₂xH₂O as well as oxycarbonates and the proton conducting perowskitic oxides such as e.g. strontium-barium-ceroxide, barium-calcium-niobate etc. as ceramic components.

Water containing particles, carrying OH-groups on their surface, preferably based on Al₂O₃ (bayerite, pseudobohmite, gibbsite=hydrargillite, diaspor, böhmit), as well as vanadium- or tungsten-based oxides (V₂O₅, VOₓ, WOₓ) or alloys from these oxides:

| | | |
|---|---|---|
| Al₂O_{3*}xH₂O | x = 1-10 | |
| V₂O_{5*}xH₂O | x = 1-10 | |
| VO_{x*}yH₂O | y = 1-10 | x = 1.5-3 |
| WO_{x*}yH₂O | y = 1-10 | x = 2-3 |

ion exchanged, especially preferred are protonated alloys of oxides, which form in their original composition the β-aluminate structure. This class of compounds is formed from alloys of the below mentioned oxides. The formulae of composition describe the range, in which the starting compound, the β-aluminate, is formed.

As preferred component Me in Me₂O Na or K is used. The produced, alkali containing compounds have to be ion exchanged before they can be used for the membrane. In doing so the alkali ion is removed and the protonated form is generated.

zMe₂O—xMgO—yAl₂O₃, _{z}Me₂O—xZnO—yAl₂O₃,
zMe₂O—xCoO—yAl₂O₃, zMe₂O—xMnO—yAl₂O₃,
zMe₂O—xNiO—yAl₂O₃, zMe₂O—xCrO—yAl₂O₃,
zMe₂O—xEuO—yAl₂O₃, zMe₂O—xFeO—yAl₂O₃,
zMe₂O—xSmO—yAl₂O₃
with Me = Na, K, z = 0.7-1.2.
(with x = 0.1-10, y = 0.1-10), stable until appr. 300° C.

Other suitable ceramic powders contain the components
   MgO, ZnO, CoO, MnO, NiO, CrO, EuO, FeO, SmO. Further suitable oxides are based on the elements
   Ti, V, Cr, Mn, Fe, Co, Ni, Cu, Zn, Zr, Nb, Mo, Ce, Ta, W, Sm, Eu, Gd, Yb, La
Other suitable, in part sparingly soluble metal salts are: phosphates and hydrogenphosphates as well as acidic and entirely neutralised diphosphates of Ti, V, Cr, Mn, Fe, Co, Ni, Cu, Zn, Zr, Nb, Mo, Ce, Ta, W, Sm, Eu, Gd, Yb, La.
Also siliciumdioxide in its different modifications is suitable as ceramic component. Especially preferred are highly dispersed siliciumdioxides, e.g. from the Aerosile® group.

Especially preferred are the oxides TiO₂, ZrO₂ and Al₂O₃ and the sparingly soluble metal phosphates Zr₃(PO₄)₄ and ZrP₂O₇ and zirconhydrogenphosphates.

(9) (Hetero)Polyacids and their Salts:

As (Hetero)polyacids can be used: polyphosphoric acid and heteropolyacids such as phosphor-tungsten-acid hydrate H₃PW₁₂O₄₀x29H₂O (TPA) and molybdatophosphoricacid hydrat H₃PMo₁₂O₄₀x29 H₂O (MPA) as well as the alkalimetalsalts of heteropolyacids such as e.g. the disodiumsalt of TPA (Na-TPA).

(10) Metal Salts Me⁺X⁻ and Covalent Metal Compounds:

The metal salts are salts of transition metal cations (e.g. of metals Ti, V, Cr, Mn, Fe, Co, Ni, Cu, Zn, Zr, Sn, Nb, Mo, Ce, Ta, W, Sm, Eu, Gd, Yb, La) or transition metal oxycations such as Zro²⁺, TiO²⁺, and anions of mineral acids, such as e.g. Hal⁻ (Hal═F, Cl, Br, I) or SO₄²⁻, which are in solvents L2 (see below) soluble. As metal salts are especially preferred ZrOCl₂, ZrOSO₄, TiOCl₂, TiOSO₄, ZrCl₄ or TiCl₄.

(11) Organic Solvent L2:

As organic solvent for the metal salts (10) mainly dipolar-aprotic solvents are suitable. As solvent L2 is DMSO especially preferred.

(13) Cation Exchange Counter Ions C⁺:

As C⁺ are in principal all dissociating cations suitable. Preferred are however alkalimetal cations or primary, secondary or tertiary ammoniumions or pyrazolium- or imidazoleiumions as well as pyridiniumions.

(14) Basic Metal Hydroxides MOH or Amines:

Suitable basic metal hydroxides are the alkali hydroxides or the alkaline-earth hydroxides, thereby NaOH and KOH are preferred. Suitable amines are ammonia or triethylamine.

(15) Sparingly Soluble Metal Oxides MeₘOₙ:

All in (8) mentioned oxides are in principle suitable as sparingly soluble metal oxides. Preferred are however the in part water-containing oxides, which form by reaction of compounds (10) with the aqueous bases (14). Thereby are especially preferred TiO₂ or ZrO₂.

Sparingly Soluble Metal Hydroxides Meₘ(OH)ₙ:

All in (8) mentioned hydroxides are in principle suitable as sparingly soluble metal hydroxides.

Mineral Acid HY:

Mono-, di- or polyphosphoric acid or heteropolyacids or sulfuric acid are suitable as mineral acids. Preferred is however ortho-phosphoric acid.

### EXAMPLES OF APPLICATION

1. Acid-Base-Blend-Composite-Membranes by Addition of a Solution of ZrOCl₂*8H₂O in Dimethylsulfoxide to the Polymer Solution

Preparations:

In this work blend membranes from sulfonated poly(etherketon) PEK (S-PEK; IEC=1,8 meq SO₃H/g Polymer) and PBI (IEC=6,5 meq basic N/g Polymer) as acid respective base component are produced. Another base (imidazolee) is used to neutralise S-PEK. As inorganic material, which is incorporated into the membranes, ZrOCl₂*8H₂O has been chosen. S-PEK and Imidazole are used as 10% solutions in NMP. A 9,5% PBI solution in DMAc was made. Due to the solubility and mixability with polymer solutions ZrOCl₂*8H₂O was dissolved in DMSO (also 10%).

| | | |
|---|---|---|
| solution 1: | S-PEK | 10% in NMP |
| solution 2: | PBI | 9.5% in DMAc |
| solution 3: | imidazolee | 10% in NMP |
| solution 4: | ZrOCl₂*8H₂O | 10% in DMSO |

To produce clear membranes, all solutions have been filtered to seperate floating particles.

Membrane Production:

S-PEK solution was neutralised with imidazolee (solution 3), then PBI (solution 2) added and stirred. Then ZrOCl₂*8H₂O was added and stirred. For comparaison a membrane was made (CPM2) from a solution without addition of ZrOCl₂*8H₂O. The polymer solution was cast on a glassplate and coated with a doctor knife (1,0 mm notch). The glass plate was immediately stored in a drying oven at 120° C. for 3 h and then over night a vacuum applied. The glass plate was cooled to room temperature and finally to remove the membrane placed for some minutes in water. The membrane was cut into 3 sections and marked as A, B or C. The sections have been post-treated as followed:
A: in 10% NaOH at 70° C., 24 h; then in DI water at 70° C., 24 h
B: in 10% NaOH at 70° C., 24 h; rinsed with water; in 10% H₃PO₄, 70° C., 24 h; then in DI water at 70° C., 24 h
C: in 10% H₃PO₄, 70° C., 24 h; then in DI water at 70° C., 24 h

The reference membrane CPM2 was treated as C, because it does not contain inorganic material.

The following membranes according to Table 1 were made:

TABLE 1
Membrane composition

| | S-PEK | Imidazole# | PBI | ZrOCl₂ * 8H₂O | ZrOCl₂ * |
|---|---|---|---|---|---|
| | [g] | [g] | [g] | [g] | 8H₂O % |
| CPM1 | 2.0015 | 0.8025 | 0.1906 | 0.3038 | 12* |
| CPM4 | 2.0017 | 0.8011 | 0.1915 | 0.6030 | 21.6* |
| CPM2 | 2.0019 | 0.8004 | 0.1962 | 0 | 0 |

(Reference)
#To neutralise the poly(etherketonsulfonic acid) SPEK
*Based to S-PEK and PBI

Results:
Swelling:

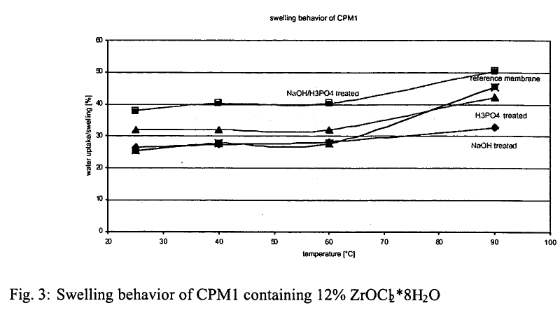

FIG. 3 shows the temperature dependant swelling of CPM1 and the reference membrane in water. At 60° C. both membranes show almost no temperature dependence. Between 60° C. and 90° C. however the water up-take of CPM1 rises circa 10% and of the reference membrane circa 20%. The swelling behaviour of the membranes treated by different ways is similar. The membrane treated by method A shows the least swelling, that by method C takes up about 10% more water.

If the quantity of ZrOCl₂*8H₂O is doubled (CPM4), the membrane reacts as follows: between 25° C. and 90° C. almost no water is taken up.

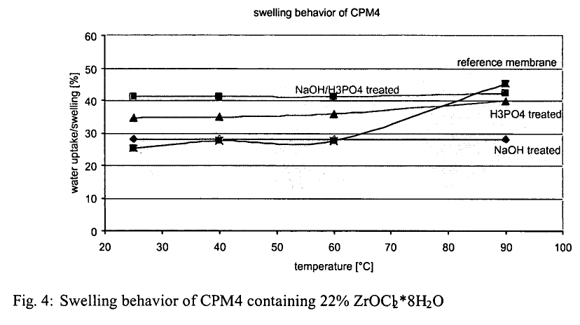

FIG. 4 shows the swelling behaviour of CPM4. The swelling of the membrane is between 28% and 45%.

The presence of the inorganic components causes apparently and surprisingly a stabilisation of the swelling over a wide temperature range.

In both cases (CPM1 and CPM4) the membrane sections treated with NaOH show the least swelling followed by those treated in H₃PO₄. The biggest water up-take capacity show the membranes post-treated in NaOH and then in H₃PO₄.

Determination of Residue with TGA:

With thermal gravimetric analysis (TGA) the residues of the mentioned membranes have been measured. First small membrane sections are dried at 100° C. for 3 days in a drying oven. Then they are cut for the thermo balance. They are heated with a heating rate of 20 K/min. under oxygen.

Table 2 shows the calculated and experimentally found residues of the membranes.

TABLE 2
Residues of membranes

| | | Residue | | Theo. ZrO(PO₃)₂ or |
|---|---|---|---|---|
| | | (TGA) % | Theo. ZrO₂ % | ZrP₂O₇ % |
| CPM1 | A | 5.4 | 5.0 | 11.1 |
| | B | 7.9 | | |
| | C | 14.8 | | |
| CPM4 | A | 8.1 | 9.4 | 16.1 |
| | B | 24.2 | | |
| | C | 15.9 | | |

| | | | |
|---|---|---|---|
| CPM2 | 0 | 0 | 0 |
| Reference | | | |

*A: treated NaOH,
*B: treated NaOH/H₃PO₄,
C: treated H₃PO₄

Membranes of the row A, post-treated in NaOH and according to equation 1 contain ZrO₂ as residue, show a good match of the calculated value with the experimental result. (CPM1-A: 5,0%/5,4%; CPM4-A: 9,4%/8,1%).

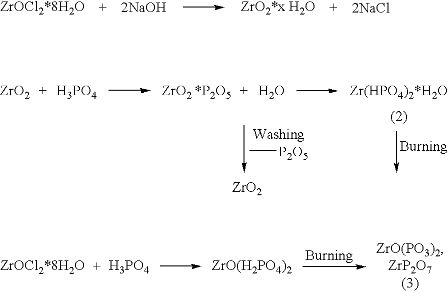

When the zirkonoxidaquat, which is formed according to eq (1) during post-treatment, is treated with phosphoric acid (membrane section B), first an adsorption takes place⁶, which is slowly superposed by the formation of zirconphosphate (eq.2). The adsorption compound contains (formally) ZrO₂ and P₂O₅, which releases on rinsing (formally) P₂O₅.
⁶ E. Wedekind, H. Wilke, Koll.-Z. 34 [1924] 283/9, 284

During the annealing of the zirconphosphate as residue according to⁷ remains zirkonylmetaphosphate ZrO(PO₃)₂. J. H. De Boer⁸ however understands the residue as diphosphate (ZrP₂O₇). Independently from the different views both formulae are identical for the explanation of the analytical results. As a result the residue of the B row is ZrO(PO₃)₂ or ZrP₂O₇.
⁷ G. v. Hevesy, K. Kimura, Z.anorg.Ch. 38 [1925] 774/6; J. Am. Soc. 47 [1925] 2540/4

⁸ J. H. De Boer, Z. Anorg. Ch. 144 [1925] 190/6

Based on the assumption that (formally) P₂O₅ is rinsed out partly during post-treatment, the experimentally found residue for CPM1-B of 7,9% corresponds to a value between pure ZrO₂ and ZrO(PO₃)₂. However the high residue for CPM4B can not be explained in this way. The zirconphosphate (membrane section C) directly obtained with H₃PO₄ from the solutions of Zr salts behaves differently. Due to the great stability of the ZrO²⁺ ion and the practical nonexistence of Zr⁴⁺ ions in aqueous solutions G. v. Hevesy and K. Kimura⁷ consider the formula ZrO(H₂PO₄)₂ as propable. In this case P₂O₅ (formally) can not be rinsed out⁶. The zirkonyldihydrogenphosphate transforms on annealing to metaphosphate ZrO(PO₃)₂. The observed residues for CPM1C and CPM4C compare well with the theoretical value for ZrO(PO₃)₂ (CPM1-C: 14,8%/11,1%, CPM4-C: 15,9%/16,1%).
⁷ G. v. Hevesy, K. Kimura, Z.anorg.Ch. 38 [1925] 774/6; J. Am. Soc. 47 [1925] 2540/4

⁶ E. Wedekind, H. Wilke, Koll.-Z. 34 [1924] 283/9, 284

The reference membrane CPM2 does not show a residue due to no inorganic components.

Ionic Capacity and Specific Resistance

The ionic capacity of a membrane is determined by soaking a membrane piece in an aqueous saturated sodium chloride solution. An ion exchange takes place Na⁺ ion diffusing into the membrane, and displacing H⁺ ions. The protons present in solution are titrated with NaOH to the equivalence point. From the consumed quantity of NaOH the direct ion capacity can be (IEC_{direct}) calculated. It corresponds to the number of free protons in the membrane. If overtitrated with NaOH, the ionic interaction of the membrane is broken. The overtitrated NaOH determined by backtitration corresponds to the quantity of ionic interaction and contributes to the total ion capacity (IECₒᵥₑᵣₐₗₗ).

Table 3 shows the experimental and theoretical ion capacity of the membranes CPM1, CPM2 and CPM4.

TABLE 3
Ion capacity and specific resistance

| | | IEC theo. | | IEC exp. | | Spec. |
|---|---|---|---|---|---|---|
| | | meq SO₃H/g | | meq SO₃H/g | | resistance |
| | | direct | overall | direct | overall | Ω * cm |
| CPM1 | A* | 0.99 | 1.55 | 0.84 | 2.05 | 28.25 |
| | B | | | 1.05 | 2.21 | 26.42 |
| | C | 0.95 | 2.22 | 0.96 | 2.59 | 34.82 |
| CPM4 | A | 0.94 | 1.48 | 0.58 | 1.96 | 10.5 |
| | B | | | 0.63 | 2.62 | 19.4 |
| | C | 0.85 | 2.67 | 0.8 | 2.53 | 29.3 |

| | | | | | |
|---|---|---|---|---|---|
| CPM2 Reference. | 1.06 | 1.64 | 0.96 | 1.52 | 39.6 |

*A: treated NaOH,
*B: treated NaOH/H₃PO₄,
C: treated H₃PO₄

For the calculation of the theoretical ion capacity of the row A (NaOH post-treatment) zircondioxide according to eq. (2) is taken into account among S-PEK and PBI in the matter balance, and for the row C(H₃PO₄ post-treatment) ZrO(H₂PO₄)₂ according to eq (3). Moreover the protons of dihydrogenphosphate are taken into account for the total ion capacity. There is no calculation for membranes of the row B (NaOH—H₃PO₄ post-treatment) because from eq. (2) is not known how much (formally) P₂O₅ is rinsed out. The IEC of this row of membranes must be intermediate compared to the IEC of the row A and C.

Good agreement between the theoretical and experimental IEC show membranes with inorganic component (CPM1 and CPM4) as well as the reference membrane without zircon compound (CPM2). Solely for the membranes post-treated with NaOH (row A) greater differences (marked in bold) are found.

Striking is the big difference between the IEC_{direct} and IEC_{overall.} of CPM1-C and CPM4-C (circa 1,5 meq SO₃H/g/g) as compared to the reference membrane (circa 0,6 meq SO₃H).

It is ascribed to the zircondihydrogenphosphate contained in these membranes, which releases both protons only in neutral to strongly basic medium⁹, and are therfore only taken into account during the determination of the total ion capacity.
⁹ Holleman, Wiberg, Lehrbuch der Anorganischen Chemie, 91.-100. [1985] 653

These additional protons provided by the dihydrogenphosphate should decrease strongly the ionic resistance of the membrane. The resistance of membranes of row C should therefore be smaller than those of row A and B. The experimental fact however show a reversed picture.

The reason of this discrepancy lies in the routine sample preparation for the determination of the membrane impedancy. For this purpose the membranes are cut into small pieces (ca. 1,5 cm×1,5 cm) and conditioned in 1N H₂SO₄. In this acidic medium the specific resistance is determined.

According to¹⁰ zirconium sulphate Zr(SO₄)₂*4H₂O is formed from a solution containing ZrO₂ and excess H₂SO₄. This exists in aqueous solution as a complex zirconium oxide sulphuric acid having the formula H₂[ZrO(SO₄)₂] and dissociates under liberation of protons according to equation 4.
¹⁰ Gmelin, Handbuch Syst. Nr. 42 [1958] 337

$${ZrO}_{2} + {H}_{2} {SO}_{4} \to {Zr ( {SO}_{4} )}_{2} * 4 {H}_{2} O {\to }^{aqueous} {H}_{2} [ {ZrO ( {SO}_{4} )}_{2} ] {\to }^{Diss .} {[ {ZrO ( {SO}_{4} )}_{2} ]}^{2 -} + 2 {H}^{+} \qquad ( 4 )$$

Presumably the same reaction occurs in the membranes of the series A and partially also in in the series B. In both cases the sulphuric acid is bound in the membrane matrix and leads to a strong decrease of resistance. Due to the fact that sulphuric acid is a strong acid the effect is the more marked.

The experimentally determined membrane impedance reflects therefore not the actual ionic resistance, because it is falsified by the presence of sulphuric acid.

It is unclear whether the ions formed by the dissociation remain in the membrane and perpetuate the state of high protone conductivity, or are washed out with time.

The sparingly soluble zirconium dihydrogen phosphate in CPM1-C and CPM4-C is not influenced by this reaction¹⁰ [5]. In the dihydrogen phosphate protons are present, they are however tightly bound and have less influence onto the proton conductivity than zirconium oxide sulfuric acid.
¹⁰ Gmelin, Handbuch Syst. Nr. 42 [1958] 337

It is certain that composite membranes of this type have a smaller ionic resistance than a entirely organic membrane.

Summary:

1) The composite membranes have a lower ionic resistance than the membranes without inorganic components
2) the specific resistance of the A- and B-series is lower than the C-series because of the included zirconium phosphate. It is unclear whether the ions which are formed by dissociation are washed out of the membrane
3) The membranes of the C-series contain zirconium dihydrogen phosphate which strongly increases the overall ion-capacity. It is assumed that the protons of the dihydrogen phosphate partially contribute to proton conductivity. This effect is indicated by a lower specific resistance compared to the membrane without inorganic components (CPM1C, CPM4C compared to CPM2.
4) The high inorganic share in CPM4 leads to a constant swelling over a large temperature range.
   Remarks:

1) Optical appearance of the membranes:

| | |
|---|---|
| a) S-PEK/Imidazolee/PBI/ZrOCl₂*8H₂O: | clear, transparent |
| b) S-PEEK/Imidazole/PBI/ZrOCl₂*8H₂O: | clear, transparent |
| c) S-PSU/ZrOCl₂*8H₂O | cloudy |
| d) PSU/ZrOCl₂*8H₂O | cloudy |

2) ZrOCl₂*8H₂O-DMSO-solution crystallizes with time. Repeating experiments of membrane preparation where the solution over the deposit is occupied, show that the membranes contain no zirconium and phosphorus (according to WDX method), and form no thermogravimetric residue.
   For this reason the solution should always be prepared freshly.
3) Mechanical stability:
   As could be ascertained via sensoric test, composite membranes, particularly in the system polyetherketone, are very stable. Over a broad mixing range no significant disadvantages, compared to entirely organic membranes, are recognizable. Only CPM4, containing an increased portion in zirconium compound, shows higher brittleness than CPM1.
      2. Composite Membranes Via Subsequent Ion-Exchange/Precipitation in Preformed Arylene Main Chain Blend Membranes

Investigated Membranes:

| Membrane | | composition | RSₛₚ^{H+} (0.5N HCl) |
|---|---|---|---|
| [Nr.] | Type | [g] | [Ω * cm]^{b} |
| 1025 H | Covalently | 4,066 PEK(SO₃H)_{0.4}^{e} | 53.7 |
| | cross-linked^{c} | 1.8 PSU(SO₂Li)^{f} | |
| 1025 I | Covalently | 4,066 PEK(SO₃H)_{0.4}^{e} | 27 |
| | cross-linked | 1.8 PSU(SO₂Li)^{f} | |
| 1030 C | Covalently | 2 PEEK(SO₃H)₁^{g} | 35.9 |
| | cross-linked | 2.3 PSU(SO₂Li)^{f} | |
| 810 H | Ionically | 4.5 PEK(SO₃H)_{0.4} | 27.2 |
| | cross-linked^{d} | 0.3 PBI^{h} | |
| | | 0.3 PSU-[C(OH)(4- | |
| | | diethylaminophenyl)₂]ⁱ | |

^{a}Impedance, measured between 2 Nafion ® 117 membranes in water
^{b}Impedance, measured between 2 Nafion ® 117 membranes in 0.5N HCl
^{c}Cross-linking via alkylation of sulfinate groups with 1,4-diiodbutane¹¹
^{d}Ionical cross-linking via proton transfer of SO₃H-group onto basic imidazole-N
^{e}sulfonated poly(etherketon)e Victrex ®
^{f}sulfinated PSU, prepared via reaction of lithiated PSU with SO₂¹²
^{g}sulfonated poly(etherethe rketon)e Victrex ®
^{h}Polybenzimidazole Celazol ®
ⁱprepared via reaction of lithiated PSU with bis(diethylamino)benzophenone¹³
¹¹Jochen Kerres, Wei Cui, Martin Junginger, J. Memb. Sci. 139, 227-241 (1998)
¹²J. Kerres, W. Cui, S. Reichle, J. Polym. Sci.: Part A: Polym. Chem. 34, 2421-2438 (1996)
¹³J. Kerres, A. Ullrich, M. Hein, J. Polym. Sci.: Part A: Polym. Chem. 39, 2874-2888 (2001)

Preparation of Post-Treatment-Solution:
1. ZrOCl₂ is dissolved in the following mixtures to a Imolar solution:
   Mixture 1: Water/NMP 70/30
   Mixture 2: Water/NMP 50/50
   Mixture 3: Water/NMP 30/70
2. 10% ige phosphoric acid is prepared via mixing of 85% phosphoric acid with water
   Membrane-Posttreatment:
1. The membranes are immersed at room temperature for 24 h in the referring 1M ZrOCl₂-solution to exchange the H⁺-ions of the sulfonic acid group with ZrO²⁺-ions.
2. The membranes are immersed at room temperature for 24 h in deionized water to remove all residual ZrOCl₂ from the membrane matrix.
3. The membranes are immersed at room temperature for 24 h in 10% phosphoric acid to precipitate Zr₃(PO₄)₄ in the membrane matrix.
4. The membranes are immersed for 24 h in deionized water, to remove excess phosphoric acid out of the membrane matrix.

Results of Resistance Measurements of the Membranes with the Respective Posttreatment:

| | Rₛₚ^{H+} | Rₛₚ^{H+} | Rₛₚ^{H+} | Rₛₚ^{H+} |
|---|---|---|---|---|
| | (0.5N HCl) | (0.5N HCl) | (0.5N HCl) | (0.5N HCl) |
| | Reference | Mixture 1 | Mixture 2 | Mixture 3 |
| membrane | [Ω * cm] | [Ω * cm] | [Ω * cm] | [Ω * cm] |
| 810 H | 53.7 | 24.4 | 15.35 | 8.07 |
| 1025 I | 27 | 49.5 | 6.62 | 8.48 |
| 1025 H | 27.2 | 51.3 | 27.3 | 5 |
| 1030 C | 35.9 | 33.03 | 48.12 | 10.2 |

From the table can be seen (apart from run-offs) that the resistance of the membranes is decreasing with an increasing portion of NMP in the 1 molar ZrOCl₂-solution The run-offs can result from the fact that the membrane-posttreatment was performed at room temperature, leading to limited accessibility of the membrane for the ion-exchange and precipitation reaction

2. Composite Membranes Via Subsequent Ion-Exchange/Precipitation in Preformed Binary Arylene Main-Chain Polymer Blend Membranes, into which Nano-Scaled Zirconium Phosphate “ZrP” was Mixed Prior to Membrane Preparation

A Preparation of Composite Membranes Via Mixture of ZrP-Powder in Polymer Solutions, which Contain an Acidic (sPEK) and a Basic Polymer (PBI)

The polymer solutions are prepared in mass relation as indicated in the table. Subsequently the anorganic “ZrP” powder is added to the polymer solution

| | | | sPEKH | PBI | | | | |
|---|---|---|---|---|---|---|---|---|
| | SPEKH* | | Soln. | soln. | | Anorganic | | |
| Name | (IEC = 1.8)/g | PBI** g | (15%) | (12.1%) | Propylamine | component/g | | wt % |
| ZrP 1a | 2.25 | 0.15 | 15 | 1.25 | 1.5 | ZrP*** | 0.12 | 5 |
| ZrP 1b | 2.25 | 0.15 | 15 | 1.25 | 1.5 | ZrP | 0.24 | 10 |
| ZrP 1c | 2.25 | 0.15 | 15 | 1.25 | 1.5 | ZrP | 0.48 | 20 |
| ZrP 1d | 2.25 | 0.15 | 15 | 1.25 | 1.5 | ZrP | 0.72 | 30 |

*sulfonated polyetherketone (Producer: Victrex), IEC = 1.8 meq SO₃H/g
**Polybenzimidazole Celazol (Producer: Celanese)
***ZrP: finely dispersed layered zirconium phosphate, prepared via precipitation from ZrOCl₂, from the group of Prof. Linkov, University of the Western Cape, South Africa

(30 g soln. for 2 membranes) onto one plate

| | |
|---|---|
| 4.5 g sPEKH (IEC = 1.8) | 30 g soln. (15%) |
| 3 ml propylamine | |
| 0.3 g PBI (10%) | 3 g soln. (10%) |

All solutions are warmed onto the magnetic stirrer prior to casting and are processed when warm.

800 μm-doctor knife, 2 membranes per glass plate, 2 h at 130° C./800 mbar, then vacuum 2 h/130° C., remove in H₂O, 2 d posttreatment with 10% HCl at 90° C., neutral-washing and 1 post-treatment at 60° C. in H₂O.

The sensoric check of the membranes yields:

| Name | Appearance | Homogeneous eity | Stability |
|---|---|---|---|
| ZrP 1a | brown, slightly turbid | slightly inhomogeneous eous | good |
| ZrP 1b | brown, slightly turbid | slightly inhomogeneous eous | good |
| ZrP 1c | brown, slightly turbid | slightly inhomogeneous eous | medium |
| ZrP 1d | brown, slightly turbid | slightly inhomogeneous eous | medium |

B Change of the Membrane-Conductivity Via Subsequent Introduction of Zirconium Compounds

Pieces of the membranes are swollen for 24 h at 60° C. in a solution of 30% NMP/70% H₂O The so-treated membranes are immersed in a 1 M ZrOCl₂ solution und again treated for 24 h at 60° C. to exchange the H⁺-ions of the sulfonic acid groups with Zr⁴⁺. The membranes are washed with H₂O and are subsequently cut into 2 similarly big pieces (A+B). The Membranes A are treated in a 10% H₃PO₄-soln for 24 h at 60° C. (column “H” in table), the Membranes B referring in 10% NaOH (column “N” in table). The pieces are again washed with H₂O and heated for 24 h at 60° C. with 10% HCl to, transform them into the SO₃H-form. After the washing with H₂O small pieces are cut off to measure with them the swelling (25-, 40-,60- and 90° C.), conductivity (only in HCl) and IEC. The further membrane pieces are again immersed in ZrOCl₂ at 60° C. for 24 h, then treatment analogous to the first sequence.
“0” means: respective property of the membrane before ZrOCl₂-H₃PO₄— or ZrOCl₂—NaOH-posttreatment
“1” means: respective property of the membrane after the 1. ZrOCl₂—H₃PO₄— or ZrOCl₂—NaOH-posttreatment

“2” means: respective property of the membrane after the 2. ZrOCl₂—H₃PO₄— or ZrOCl₂—NaOH-posttreatment

| Zr₃(PO₄)₄ | ZrP 1 a | | ZrP 1 b | | ZrP 1 c | | ZrP 1 d | |
|---|---|---|---|---|---|---|---|---|
| Swelling 0 25° C. | 39.36 [%] | | 35.14 | | 35.48 | | 31.03 | |
| Swelling 0 40° C. | 43.62 | | 40.54 | | 35.48 | | 34.48 | |
| Swelling 0 60° C. | 47.87 | | 44.16 | | 43.01 | | 35.63 | |
| Swelling 0 90° C. | 104.26 | | 98.20 | | 92.47 | | 81.61 | |
| Spec. resistance 0 | 7.79 [Ohm · cm] | | 9.35 | | 6.86 | | 9.11 | |
| [HCl] | (78) | | (67) | | (70) | | (73) | |
| IEC directly | 1.25 | | 1.28 | | 1.29 | | 1.27 | |
| IEC overall | 1.80 | | 2.02 | | 2.17 | | 2.37 | |
| Swelling 1 25° C. | 44.66 | 54.24 | 44.93 | 54.0 | 43.10 | 46.0 | 41.44 | 44.0 |
| Swelling 1 40° C. | 48.54 | 59.32 | 45.65 | 56.0 | 44.83 | 56.0 | 44.14 | 56.0 |
| Swelling 1 60° C. | 48.54 | 66.10 | 45.65 | 62.0 | 45.69 | 58.0 | 44.14 | 62.0 |
| Swelling 1 90° C. | 48.54 | 98.31 | 47.10 | 98.0 | 45.69 | 88.0 | 44.14 | 90.0 |
| Spec. resistance 1 | 16.99 | 7.32 | 15.27 | 9.75 | 15.06 | 6.69 | 10.69 | 7.68 |
| IEC directly | 0.40 | / | 0.38 | 1.30 | 0.35 | 1.18 | 0.38 | 1.30 |
| IEC overall | 3.87 | / | 2.75 | 2.28 | 2.62 | 1.97 | 2.95 | 2.04 |
| Swelling 2 25° C. | 42.03 | 43.88 | 41.94 | 44.32 | 38.33 | 45.0 | / | 47.27 |
| Swelling 2 40° C. | 42.03 | 48.98 | 41.94 | 48.86 | 43.33 | 51.0 | / | 50.91 |
| Swelling 2 60° C. | 43.48 | 50.0 | 41.94 | 48.86 | 45.0 | 51.0 | / | 56.36 |
| Zr₃(PO₄)₄ | ZrP 1 a | ZrP 1 b | ZrP 1 c | ZrP 1 d | Zr₃(PO₄)₄ | ZrP 1 a | ZrP 1 b | ZrP 1 c |
| Swelling 2 90° C. | 43.48 | 54.08 | 43.55 | 61.36 | 45.0 | 61.0 | / | 69.09 |
| Spec. resistance 2 | 14.47 | 10.39 | 14.82 | 6.48 | 11.27 | 23.21 | 14.32 | 7.01 |
| IEC directly | 1.71 | 0.08 | 1.97 | 0.07 | 1.82 | 0.09 | 1.76 | 0.08 |
| IRC overall | 5.13 | 0.25 | 5.83 | 0.21 | 5.20 | 0.17 | 5.88 | 0.17 |
| | H | N | H | N | H | N | H | N |

4. Composite Membranes Viasubsequent Ion-Exchange/Precipitation in Preformed Ternary Arylene Main-Chain Polymer Blend Membranes, into which was Mixed a Zirconium Phosphate “ZrP” as Nano-Scaled Powder Prior to Membrane Preparation
a Preparation of Composite Membranes Via Mixture of ZrP-Powder in Polymer Solutions, Containing an Acidic Polymer (sPEK) and Two Basic Polymers (PBI and PSU-Ortho-Sulfone-(C(Oh)(4-diethylaminophenyl)₂)

The polymer solutions are prepared in the mass relations which are indicated in the table. Subsequently the inorganic “ZrP” powder is added to the polymer solution.

| | | | sPEKH | | Propyl- | | | | |
|---|---|---|---|---|---|---|---|---|---|
| | | | Soln. | PBI soln. | Amin/ | inorg. | | wt % in | A 1105 |
| Name | sPEKH*/g | PBI/g | (15%)/g | (11.47%)/g | ml | component/g | | Membrane | (15%)**** |
| ZrP | 2.25 | 0.15 | 15 | 1.31 | 1.5 | ZrP*** | 0.12 | 5 | 1 |
| 2a | | | | | | | | | |
| ZrP | 2.25 | 0.15 | 15 | 1.31 | 1.5 | ZrP | 0.24 | 10 | 1 |
| 2b | | | | | | | | | |
| ZrP | 2.25 | 0.15 | 15 | 1.31 | 1.5 | ZrP | 0.48 | 20 | 1 |
| 2c | | | | | | | | | |
| ZrP | 2.25 | 0.15 | 15 | 1.31 | 1.5 | ZrP | 0.72 | 30 | 1 |
| 2d | | | | | | | | | |

*sulfonated Polyetherketone (Producer: Victrex), IEC = 1.8 meq SO₃H/g
**Polybenzimidazole Celazol (Producer: Celanese)
***ZrP: finely dispersed layered zirconium phosphate, prepared via precipitation from ZrOCl₂, from the group of Prof. Linkov, University of the Western Cape, South Africa
****structure-formula:

### Composition of the Standard Membrane 504 Without ZrP)

| | | | sPEKH | | | |
|---|---|---|---|---|---|---|
| | sPEKH | | Soln. | PBI soln. | Propyl- | A 1105 |
| Name | (IEC = 1.8)/g | PBI g | (15%) | (11.47%) | amine | (15%) |
| St 1a | 2.25 | 0.15 | 15 | 1.31 | 1.5 | 1 |
| St 1b | 2.25 | 0.15 | 15 | 1.31 | 1.5 | 1 |

| | |
|---|---|
| (30 g soln. for 2 membranes) onto one plate | 30 g soln. (15%) |
| 4.5 g sPEKH (IEC = 1.8) | |
| 3 ml propylamine | 2.61 g soln. (10%) |
| 0.3 g PBI (11.47%) | |

All solutions are warmed onto the magnetic stirrer prior to casting and are processed when warm.

60-doctor knife, 2 membranes per glass plate, 2 h at 130° C./800 mbar, then vacuum 2 h/130° C., remove in H₂O, 2 d posttreatment with 10% HCl at 90° C., neutral washing and 1 post-treatment at 60° C. in H₂O

The sensoric check of the membranes yields:

| Name | Appearance | Homogene eity | Stability |
|---|---|---|---|
| ZrP 2a | light-brown, slightly | homogeneous | good |
| | turbid | | |
| ZrP 2b | light-brown, slightly | homogeneous | medium |
| | turbid | | |
| ZrP 2c | light-brown, slightly | homogeneous | bad |
| | turbid | | |
| ZrP 2d | light-brown, slightly | homogeneous | bad |
| | turbid | | |
| St 1a | green, transparent | homogeneous | very good |
| St 1b | green, transparent | homogeneous | very good |

b Change of the Membrane-Conductivity Via Subsequent Introduction of Zirconium Compounds

Pieces of the membranes are swollen for 24 h at 60° C. in a solution of 30% NMP/70% H₂O The so-treated membranes are immersed in a 1 M ZrOCl₂ solution und again treated for 24 h at 60° C. to exchange the H⁺-ions of the sulfonic acid groups with Zr⁴⁺. The membranes are washed with H₂O. The membranes are treated in a 10% H₃PO₄-soln for 24 h at 60° C.

The pieces are again washed with H₂O and heated for 24 h at 60° C. with 10% HCl to, transform them into the SO₃H-form. After the washing with H₂O small pieces are cut off to measure with them the swelling (25-, 40-,60- and 90° C.), conductivity (only in HCl) and IEC.

“0” means: respective property of the membrane before ZrOCl₂-H₃PO₄-posttreatment

“1” means: respective property of the membrane after the 1. ZrOCl₂—H₃PO₄-posttreatment

| A 504 Stand. 1 | St 1a | | A 504 | | St 1b | | | |
|---|---|---|---|---|---|---|---|---|
| | | | Stand. 2 | | | | | |
| Swelling 0 25° C. | 25.40 | | Swelling 0 | | 22.55 | | | |
| | [%] | | 25° C. | | [%] | | | |
| Swelling 0 40° C. | 26.98 | | Swelling 0 | | 23.53 | | | |
| | | | 40° C. | | | | | |
| Swelling 0 60° C. | 30.16 | | Swelling 0 | | 24.51 | | | |
| | | | 60° C. | | | | | |
| Swelling 0 90° C. | 45.24 | | Swelling 0 | | 38.24 | | | |
| | | | 90° C. | | | | | |
| Spec. resistance 0 | 41.42 | | Spec. | | 43.88 | | | |
| [HCl] | [Ohm · cm] | | resistance 0 | | [Ohm · cm] | | | |
| | (53) | | [HCl] | | (40) | | | |
| IEC directly | 1.17 | | IEC directly | | 1.14 | | | |
| IEC overall | 1.59 | | IEC overall | | 1.74 | | | |
| Zr₃(PO₄)₄ | ZrP 2a | | ZrP 2b | | ZrP 2c | | ZrP 2d | |
| Swelling 0 25° C. | 26.94 [%] | | 23.21 | | 26.14 | | 22.45 | |
| Swelling 0 40° C. | 30.05 | | 26.79 | | 29.55 | | 26.53 | |
| Swelling 0 60° C. | 30.57 | | 28.57 | | 32.95 | | 34.69 | |
| Swelling 0 90° C. | 47.15 | | 39.29 | | 45.45 | | 38.78 | |
| Spec. resistance 0 | 52.50 | | 40.87 | | 48.16 | | 45.23 | |
| [HCl] | [Ohm · cm] | | (63) | | (56) | | (66) | |
| | (50) | | | | | | | |
| IEC directly | 1.14 | | 1.13 | | 1.18 | | 1.06 | |
| IEC overall | 1.88 | | 2.15 | | 2.42 | | 1.59 | |
| Swelling 1 25° C. | / | / | 61.34 | / | 45.83 | / | / | / |
| Swelling 1 40° C. | / | / | 89.08 | / | 45.83 | / | / | / |
| Swelling 1 60° C. | / | / | 89.08 | / | 45.83 | / | / | / |
| Swelling 1 90° C. | / | / | 89.08 | / | 45.83 | / | / | / |
| Spec. resistance 1 | / | / | 87.61 | / | 151.29 | / | / | / |
| IEC directly | / | / | 1.32 | / | 1.40 | / | / | / |
| IEC overall | / | / | 3.50 | / | 4.03 | / | / | / |
| | H | N | H | N | H | N | H | N |

5. Composite Membranes Via Subsequent Ion-Exchange/Precipitation in Preformed Ionically and/or Covalently Cross-Linked Arylene Main-Chain Polymer Blend Membranes
5.1 Membrane Preparation
5.1.1 Membrane 1202

The following polymers are mixed as 15 wt % solutions in N-methylpyrrolidinone (NMP):
4,222 g sulfochlorinated PEKEKK Ultrapek (IEC=3 meq SO₃H/g polymer (hydrolysed))
5,52 g PSU—SO₂Li (1 group per repeating unit)

After the homogenisation 0,7 ml diiodbutane are syringed into the polymer solution. After that a thin film of the polymer solution is cast onto a glass plate with a doctor knife to a thin film. The solvent is evaporated in a vacuum drying oven following the following method:
1) 2 hours at 90° C. and 800 mbar
2) 3 hours at 130° C. and 150-50 mbar

Subsequently the glass plate with the membrane is removed fom the drying oven, and after cooling down it is immersed in a water bath. There the membrane comes off the glass plate. The membrane is posttreated in the following manner:

1) 48 h at 25° C. in 10% NaOH

2) 48 h at 90° C. in 7% HCl

3) 48 h at 60° C. in H₂O

Then the membrane is characterized.

5.1.2 Membrane 1203

The following polymers are mixed as 15 wt % solutions in N-methylpyrrolidinone (NMP):
4,222 g sulfochlorinated PSU(SO₂Cl)₂ (IEC=3 meq SO₃H/g Polymer (hydrolysed))
5,52 g PSU—SO₂Li (1 group per repeating unit)

After the homogenisation 0,7 ml diiodbutane are syringed into the polymer solution. After that a thin film of the polymer solution is cast onto a glass plate with a doctor knife to a thin film. The solvent is evaporated in a vacuum drying oven following the following method:
3) 2 hours at 90° C. and 800 mbar
4) 3 hours at 130° C. and 150-50 mbar

Subsequently the glass plate with the membrane is removed from the drying oven, and after cooling down it is immersed in a water bath. There the membrane comes off the glass plate. The membrane is posttreated in the following manner:

1) 48 h at 25° C. in 10% NaOH

2) 48 h at 90° C. in 7% HCl

3) 48 h at 60° C. in H₂O

Then the membrane is characterized.

5.1.3 Membrane 1204

At first 4 g sulfonated PEKEKK are dissolved to a 15 wt % solution in NMP, then 1,95 g carbonyldiimidazole are added to the solution to mask the SO₃H group. Then 1,95 g PSU-ortho-sulfone(C(OH)CH₃(4-Pyridyl))_{1,5} are added as a 15 wt % solution to the reaction mixture.

After the homogenisation a thin film of the polymer solution is cast onto a glass plate with a doctor knife to a thin film. The solvent is evaporated in a vacuum drying oven following the following method:
5) 2 hours at 90° C. and 800 mbar
6) 3 hours at 130° C. and 150-50 mbar

Subsequently the glass plate with the membrane is removed from the drying oven, and after cooling down it is immersed in a water bath. There the membrane comes off the glass plate. The membrane is posttreated in the following manner:

1) 48 h at 25° C. in 10% NaOH

2) 48 h at 90° C. in 7% HCl

3) 48 h at 60° C. in H₂O

Then the membrane is characterized.

5.1.4 Membrane 1205

At first 4 g sulfonated PEKEKK are dissolved to a 15 wt % solution in NMP, then 1,95 g carbonyldiimidazole are added to the solution to mask the SO₃H group. Then 1,95 g PSU ortho-sulfone(C(OH)CH₃(4-Pyridyl))_{1,5} are added as a 15 wt % solution to the reaction mixture. Subsequently still 2,6 g PSU(SO₂Li) (1 group per repeating unit) are added to the solution, and finally 0,48 ml 1,4-diiodobutane are syringed into the reaction mixture.

After the homogenisation a thin film of the polymer solution is cast onto a glass plate with a doctor knife to a thin film. The solvent is evaporated in a vacuum drying oven following the following method:
7) 2 hours at 90° C. and 800 mbar
8) 3 hours at 130° C. and 150-50 mbar

Subsequently the glass plate with the membrane is removed from the drying oven, and after cooling down it is immersed in a water bath. There the membrane comes off the glass plate. The membrane is posttreated in the following manner:

1) 48 h at 25° C. in 10% NaOH

2) 48 h at 90° C. in 7% HCl

3) 48 h at 60° C. in H₂O

Then the membrane is characterized.

5.1.5 Membrane 504

At first 4,5 g sulfonated PEK (IEC=1,8 meq/g) are dissolved to a 15 wt % solution in NMP, then 3 ml npropylamine are added to the solution to neutralize the SO₃H-groups. After that 0,3 g PSU-ortho-sulfone(C(OH)(4-diethylaminophenyl)₂ as 15 wt % solution are added to the reaction mixture. then still 0,3 g Polybenzimidazole PBI Celazol® are added to the solution as a 8,755 wt % solution

After the homogenisation a thin film of the polymer solution is cast onto a glass plate with a doctor knife to a thin film. The solvent is evaporated in a vacuum drying oven following the following method:
9) 2 hours at 90° C. and 800 mbar
10) 3 hours at 130° C. and 150-50 mbar

Subsequently the glass plate with the membrane is removed from the drying oven, and after cooling down it is immersed in a water bath. There the membrane comes off the glass plate. The membrane is posttreated in the following manner:

1) 48 h at 25° C. in 10% NaOH

2) 48 h at 90° C. in 7% HCl

3) 48 h at 60° C. in H₂O

Then the membrane is characterized.

5.2 Membrane Posttreatment with ZrOCl₂—H₃PO₄

5.2.1 1. Cycle

The membranes are immersed two days at 60° C. in a 1M ZrOCl₂-solution Subsequently the membranes are immersed 2 days at 60° C. in water, then 2 days at 60° C. in 10% H₃PO₄, and finally 2 days in water.

5.2.2 2. Cycle

The membranes are immersed 3 days at 60° C. in a 1M ZrOCl₂-solution. Subsequently the membranes are immersed 2 days at 60° C. in water, then 2 days at 60° C. in 10% H₃PO₄, and finally 2 days in water.

5.2.3 3. Cycle

The membranes are immersed 3 days at 60° C. in a 1M ZrOCl₂-solution. Subsequently the membranes are immersed 2 days at 60° C. in water, then 2 days at 60° C. in 10% H₃PO₄, and finally 2 days in water.

5.3 Membrane Characterization

In the following table are listed the characterization results of the membranes. “2d” means the characterization results after the first posttreatment-cycle with ZrOCl₂—H₃PO₄, “5d” the characterization results after the second posttreatment cycle with ZrOCl₂—H₃PO₄, and “8d” the characterization results after the third posttreatment cycle with ZrOCl₂—H₃PO₄.

| Membrane | IEC¹⁴ | Rₛₚ^{H+15} | SW¹⁶ | IEC(overall)¹⁷ |
|---|---|---|---|---|
| [Nr.] | [meq/g] | [Ω * cm] | [%] | [meq/g] |
| 1203-1b | 0.905 | 63.29 | 34.54 | 0.905 |
| 2d | 0.97 | 38.64 | 19.15 | 1.53 |
| 5d | 0.99 | 38.4 | 17.56 | 1.36 |
| 8d | 1.07 | 43.05 | 17.58 | 2.05 |
| 1202-2b | 1.174 | 3.51 | 43.85 | 1.174 |
| 2d | 1.32 | 23.32 | 30.4 | 2.61 |
| 5d | 1.3 | 23.94 | 26.09 | 2.45 |
| 8d | 1.3 | 24.53 | 25.93 | 2.42* |
| 2d | 1.41 | 6.77 | 74.69 | 3.79 |
| 5d | 1.51 | 9.12 | 51.74 | 3.67 |
| 8d | 1.41 | 11.81 | 37.7 | 2.73* |
| 1205 | 1.295 | 10.04 | 68.89 | 1.37 |
| 2d | 1.04 | 10.11 | 67.73 | 2.42 |
| 5d | 1.04 | 13.04 | 23.88 | 2.35 |
| 8d | 1.13 | 24.73 | 19.68 | 2.23* |
| A504 | 1.5 | 18.57 | 32.28 | 1.93 |
| 2d | 1.37 | 12.17 | 35.62 | 2.6 |
| 5d | 1.57 | 10 | 36.36 | 2.84 |
| 8d | 1.45 | 11.12 | 35.64 | 3.64 |

¹⁴Direct titration with 0.1 N NaOH
¹⁵Specific resistance, measured via Impedance spectroscopy in 0.5 N HCl
¹⁶Water uptake (Swelling) at 25° C., determined via SW = ((m_{naβ} − m_{trocken})/m_{trocken}) * 100
¹⁷Back titration: at first addition of an excess of 0.1 N NaOH, then back-titration with 0.1 N HCl

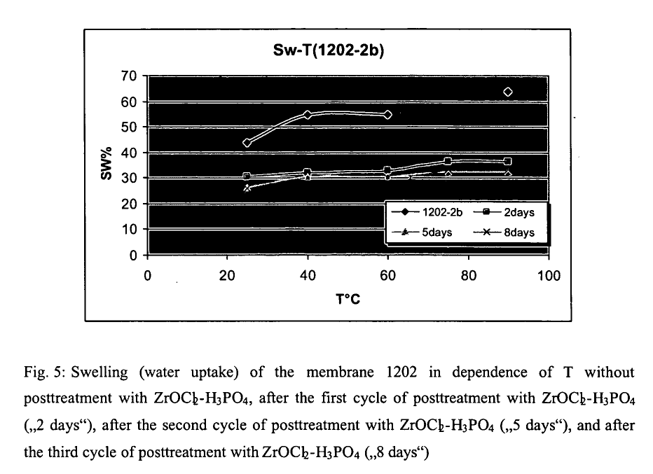

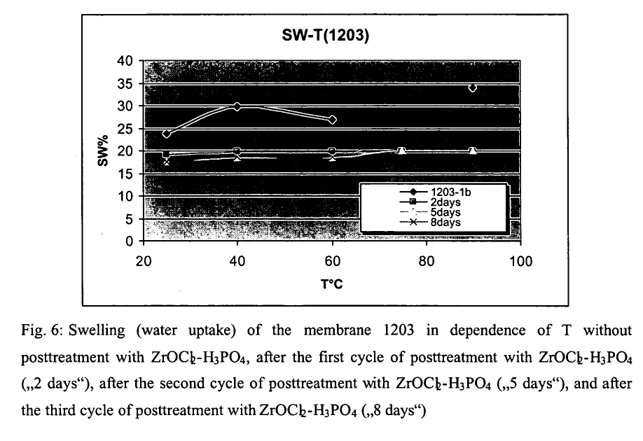

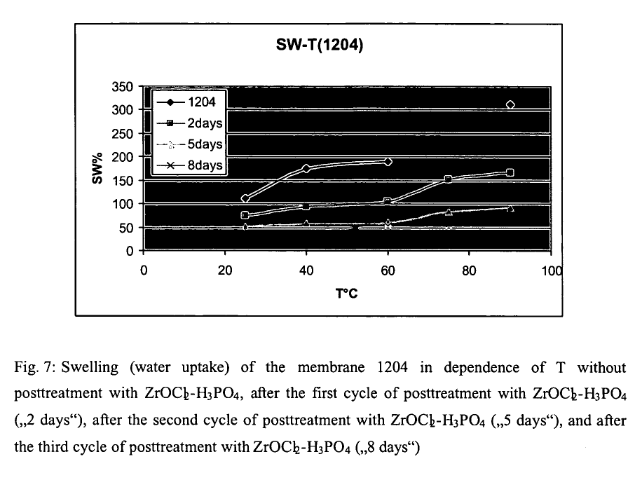

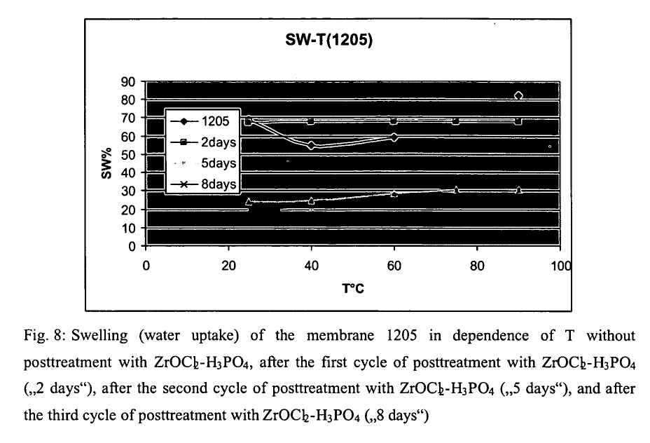

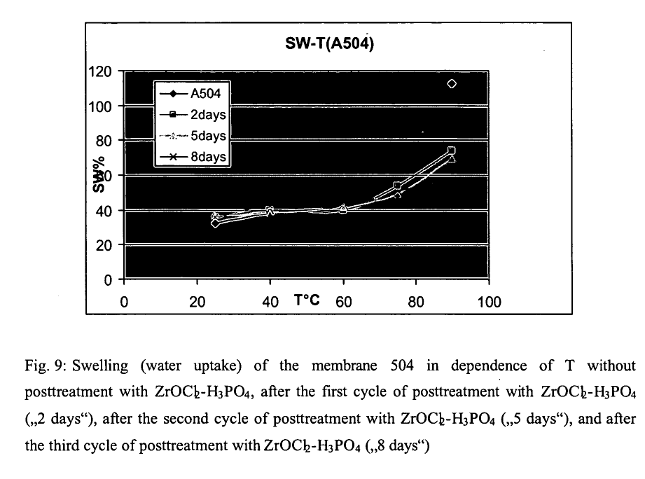

In the following figures the swelling (water uptake) of the membranes 1202 (FIG. 5), 1203 (FIG. 6), 1204 (FIG. 7), 1205 (FIG. 8), and 504 (FIG. 9) in dependence of T is shown without posttreatment, after the first cycle of posttreatment with ZrOCl₂-H₃PO₄ (“2 days”), after the second cycle of posttreatment with ZrOCl₂—H₃PO₄ (“5 days”), and after the third cycle of postreatment with ZrOCl₂—H₃PO₄ (“8 days”), is shown.

One sees from the figures that the posttreatment with ZrOCl₂—H₃PO₄ leads to a strong reduction of water uptake, and partially even to an increase in proton conductivity. This was not to be foreseen and is therefore surprising.

1. Ionically cross-linked composite membrane, consisting of:
a) a polymer A with at least cation exchange groups or their non ionic precursors and a polymer B with at least anion exchange groups and/or N-basic groups and an inorganic salt and/or oxide and/or hydroxide, which has been precipitated by a hydrolysis process and/or precipitation process in the membrane matrix and if necessary a hetero polyacid or a polyacid or their alkali metal salts and if necessary a fine, if necessary nano-sized sparingly soluble salt powder, oxide powder or hydroxide powder, which has been added to the polymer solution as a powder or
b) a polymer D1 with cation exchange groups or their non-ionic precursors and anion exchange groups and/or other N-basic groups and a polymer B with at least anion exchange groups and/or N-basic groups and an inorganic salt and/or oxide and/or hydroxide, which has been precipitated in the membrane matrix by a hydrolysis process and/or precipitation process and if necessary a hetero polyacid or a polyacid or their alkali metal salts and if necessary a fine, if necessary nano-sized sparingly soluble salt powder, oxide powder or hydroxide powder, which has been added to the polymer solution as a powder or
c) a polymer D1 with cation exchange groups or their non-ionic precursors and anion exchange groups and/or other N-basic groups and a polymer B with at least anion exchange groups and/or N-basic groups and an inorganic salt and/or oxide and/or hydroxide, which has been precipitated in the membrane matrix by a hydrolysis process and/or precipitation process and if necessary a hetero polyacid or a polyacid or their alkali metal salts and if necessary a fine, if necessary nano-sized sparingly soluble salt powder, oxide powder or hydroxide powder, which has been added to the polymer solution as a powder.

2. Covalently cross-linked composite membrane, consisting of:
a) a polymer A with at least cation exchange groups or their non ionic precursors and a polymer C with at least cross-linking groups, which have been cross-linked by a cross-linking agent or cross-linking starter and an inorganic salt and/or oxide and/or hydroxide, which has been precipitated by a hydrolysis process and/or precipitation process in the membrane matrix and if necessary a hetero polyacid or a polyacid or their alkali metal salts and if necessary a fine, if necessary nano-sized sparingly soluble salt powder, oxide powder or hydroxide powder, which has been added to the polymer solution as a powder or
b) a polymer D2 with cation exchange groups or their non-ionic precursors and at least cross-linking groups, which have been cross-linked by a cross-linking agent or cross-linking starter and a polymer C at least cross-linking groups, which have been cross-linked by a cross-linking agent or cross-linking starter and an inorganic salt and/or oxide and/or hydroxide, which has been precipitated by a hydrolysis process and/or precipitation process in the membrane matrix and if necessary a hetero polyacid or a polyacid or their alkali metal salts and if necessary a fine, if necessary nano-sized sparingly soluble salt powder, oxide powder or hydroxide powder, which has been added to the polymer solution as a powder or
c) a polymer D2 with cation exchange groups or their non ionic precursors and at least cross-linking groups, which have been cross-linked by a cross-linking agent or cross-linking starter and a polymer B with at least anion exchange groups and/or N-basic groups and an inorganic salt and/or oxide and/or hydroxide, which has been precipitated by a hydrolysis process and/or precipitation process in the membrane matrix and if necessary a hetero polyacid or a polyacid or their alkali metal salts and if necessary a fine, if necessary nano-sized sparingly soluble salt powder, oxide powder or hydroxide powder, which has been added to the polymer solution as a powder.

3. Covalently-ionically cross-linked composite membrane consisting of:
a) a polymer A and a polymer C and a polymer B and an inorganic salt and/or oxide and/or hydroxide, which has been precipitated by a hydrolysis process and/or precipitation process in the membrane matrix and if necessary a hetero polyacid or a polyacid or their alkali metal salts and if necessary a fine, if necessary nano-sized sparingly soluble salt powder, oxide powder or hydroxide powder, which has been added to the polymer solution as a powder or
b) a polymer D2 and a polymer B and an inorganic salt and/or oxide and/or hydroxide, which has been precipitated by a hydrolysis process and/or precipitation process in the membrane matrix and if neccessary a hetero polyacid or a polyacid or their alkali metal salts and if neccessary a fine, if neccessary nano-sized sparingly soluble salt powder, oxide powder or hydroxide powder, which has been added to the polymer solution as a powder or
c) a polymer D1 and a polymer C and an inorganic salt and/or oxide and/or hydroxide, which has been precipitated by a hydrolysis process and/or precipitation process in the membrane matrix and if necessary a hetero polyacid or a polyacid or their alkali metal salts and if necessary a fine, if necessary nano-sized sparingly soluble salt powder, oxide powder or hydroxide powder, which has been added to the polymer solution as a powder or
d) a polymer A and a polymer B and an inorganic salt and/or oxide and/or hydroxide, which has been precipitated by a hydrolysis process and/or precipitation process in the membrane matrix and if necessary a hetero polyacid or a polyacid or their alkali metal salts and if necessary a fine, if necessary nano-sized sparingly soluble salt powder, oxide powder or hydroxide powder, which has been added to the polymer solution as a powder or
e) a polymer D4 with cation exchange groups or their non-ionic precursors and anion exchange groups or other N-basic groups and with crosslinking groups and an inorganic salt and/or oxide and/or hydroxide, which has been precipitated by a hydrolysis process and/or precipitation process in the membrane matrix and if necessary a hetero polyacid or a polyacid or their alkali metal salts and if necessary a fine, if necessary nano-sized sparingly soluble salt powder, oxide powder or hydroxide powder, which has been added to the polymer solution as a powder
or
f) a polymer A and a polymer D3 anion exchange groups and/or other N-basic groups and with crosslinking groups and an inorganic salt and/or oxide and/or hydroxide, which has been precipitated by a hydrolysis process and/or precipitation process in the membrane matrix and if necessary a hetero polyacid or a polyacid or their alkali metal salts and if necessary a fine, if necessary nano-sized sparingly soluble salt powder, oxide powder or hydroxide powder, which has been added to the polymer solution as a powder.

4. Membranes according to the claims 1 to 3, characterized in that the polymer main chains of the polymers A, B, C, D1, D2, D3 and D4 are selected from:
Polyolefines such as polyethylene, polypropylene, polyisobutylene, polynorbornene, polymethylpentene, poly(1,4-isoprene), poly(3,4-isoprene), poly(1,4-butadiene), poly(1,2-butadiene),
styrol(co)polymers such as polystyrol, poly(methylstyrol), poly(α,β,β-trifluorstyrol), poly(pentafluorostyrol),
perfluorinated ionomers such as Nafion® or the SO₂Hal precursor of Nafion® (Hal═F, Cl, Br, I), Dow® membrane, GoreSelect® membrane,
N-basic polymers such as polyvinylcarbazole, polyethylenimine, poly(2-vinylpyridine), poly(3-vinylpyridine), poly(4-vinylpyridine),
(Het)arylmain chain polymers containing the following construction units:
polymer building blocks: 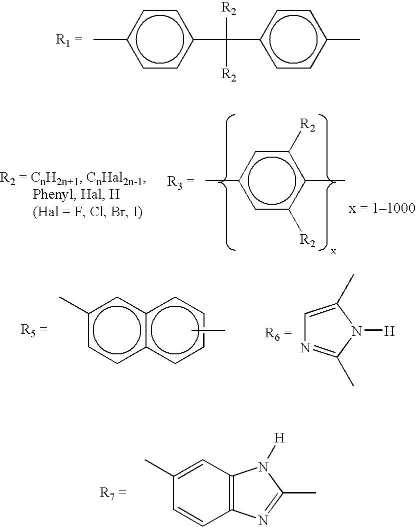
bridging groups:

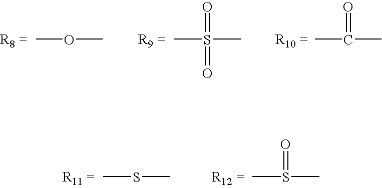

5. Membranes according to claim 4, characterized in that the main chains of the polymers A, B, C, D1, D2, D3 and D4 are selected from:
polyetherketones such as polyetherketone PEK Victrex®, polyetheretherketone PEEK Victrex®, polyetheretherketonketone PEEKK, polyetherketonether-ketonketone PEKEKK Ultrapek®, polyetherketonketone PEKK
polyethersulfone such as polysulfone Udel®, polyphenylsulfone Radel R®, polyetherethersulfone Radel A®, polyethersulfone PES Victrex®
poly(benz)imidazole such as PBI Celazol® and other oligomers and polymers containing the (benz)imidazo unit, in which the (benz)imidazole group can be present in the main chain or in the side chain
polyphenylene ether such as e.g. poly(2,6-dimethyloxyphenylene), poly(2,6-diphenyloxyphenylene)
polyphenylensulfides and copolymers
poly(1,4-phenylenes) or poly(1,3-phenylenes), which can be modified in the side chain with benzoyl-, naphtoyl- or o-phenyloxy-1,4-benzoylgroups, m-phenyloxy-, 1,4-benzoylgroups or p-phenyloxy-1,4-benzoylgroups,
poly(benzoxazole) and copolymers
poly(benzthiazole) and copolymers
poly(phtalazinone) and copolymers
polyanilin and copolymers
polythiazol
polypyrrol

6. Membranes according to claims 1 to 5, characterized in that the cation exchange groups or their non ionic precursor are selected from
SO₃H, SO₃Me; PO₃H₂, PO₃Me₂; COOH, COOMe
SO₂X, POX₂, COX with X represents Hal, OR₂, N(R₂)₂, anhydride radical, N-imidazole radical 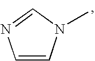
N-pyrazole radical 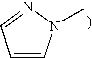
with Me represents any cation.

7. Membranes according to claim 6, characterized in that as functional groups the following groups are preferred:
SO₃H, SO₃Me; PO₃H₂, PO₃Me₂ respectively. SO₂X, POX₂.

8. Membranes according to claims 1 to 7, characterized in that the anion exchange groups or N-basic groups are selected from:
N(R₂)₃⁺Y⁻, P(R₂)₃⁺Y⁻, in which the radicals R₂ can be the same or different;
N(R₂)₂ (primary, secondary or tertiary amines);
polymers with the following N-basic (het)aryl groups and heterocyclic groups 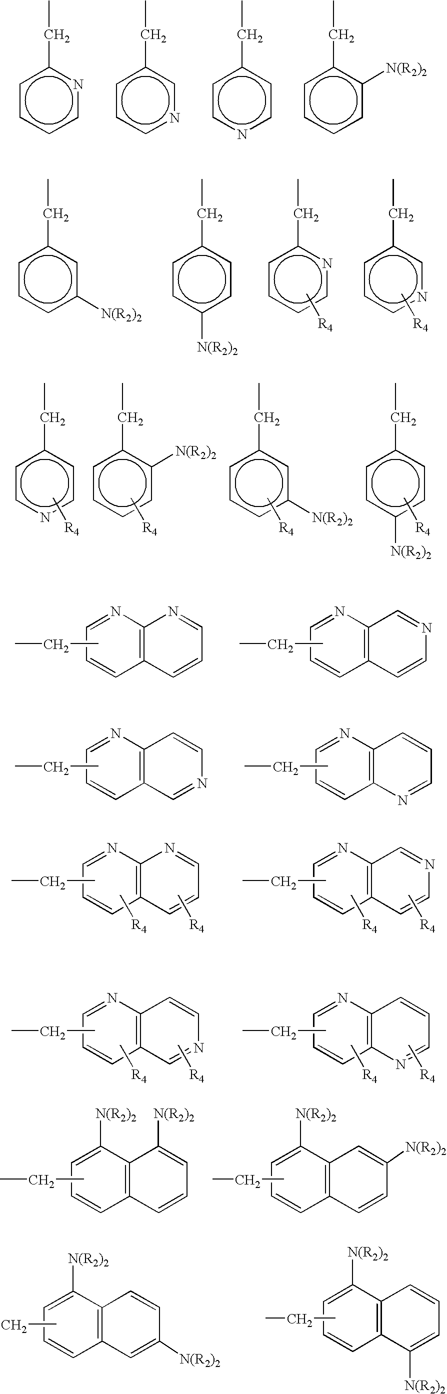 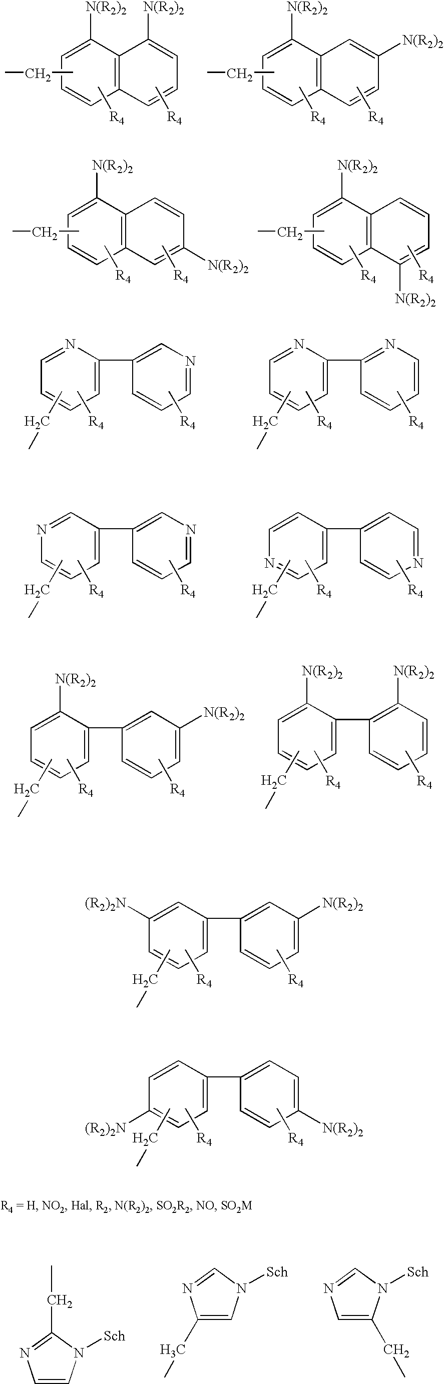 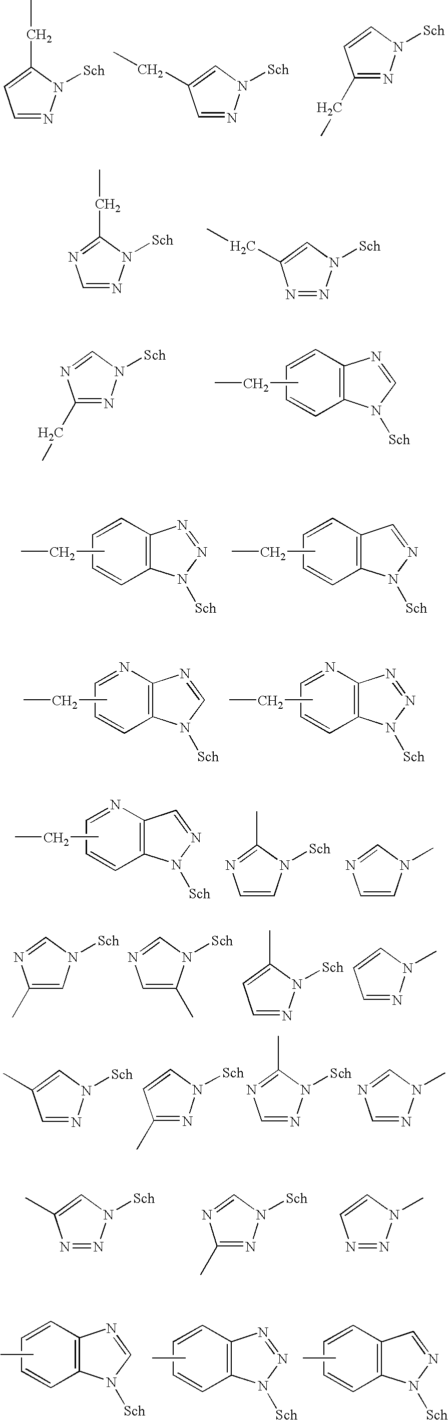 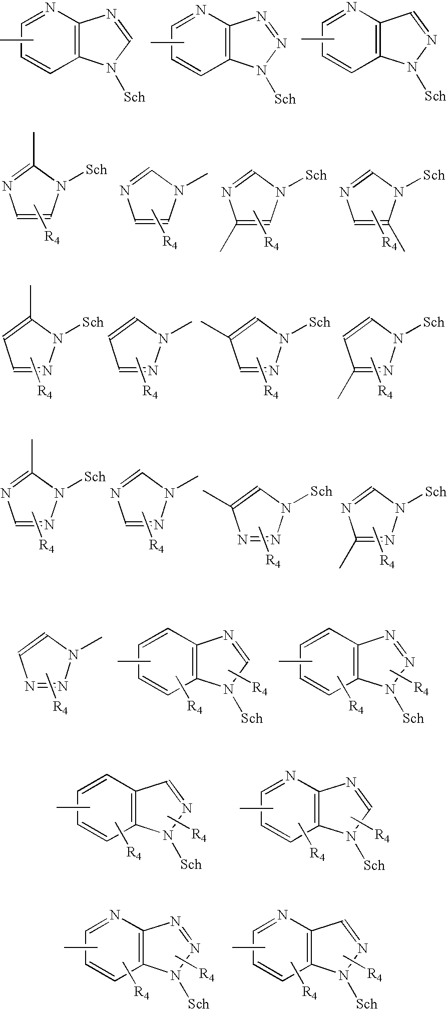
Sch=protection group=Trityl (Triphenylmethyl) or Boc, CBz, Dan, Tos, Tfa, Aca, FMOC, THP, 9-BBN

9. Membranes according to claim 8, characterized in that as basic grups primary, secondary and tertiary aminogroups, pyridyl groups and imidazole groups are preferred, in which the imidazole groups can be present in the main chain or in the side chain.

10. Membranes according to claims 1 to 9, characterized in that the polymers contain the following cross-linking groups:
a) alkene groups: polymer-C(R₁₃)═C(R₁₄R₁₅) with R₁₃, R₁₄, R₁₅═R₂ or R₄
b) polymer-Si(R₁₆R₁₇)—H with R₁₆, R₁₇═R₂ or R₄
c) polymer-COX, polymer-SO₂X, polymer-POX₂
d) sulfinate groups polymer-SO₂Me
e) polymer-N(R₂)₂ with R₂≠H
and that the cross-linking can be carried out by:
(I) group a) by addition of peroxides;
(II) group a) with group 4b) by Pt-catalysis via hydrosilylation;
(III) group d) with dihalogenalkane- or dihalogenaryl cross-linking agents (e.g. Hal-(CH₂)ₓ-Hal, x represents a number between 3 and 20) by S-alkylation of the sulfinate group;
(IV) group e) with dihalogenalkane- or dihalogenaryl cross-linking agents (e.g. Hal-(CH₂)ₓ—Hal, x represents a number between 3 and 20) by alkylation of the tertiary basic N group,
(V) group d) and group e) with dihalogenalkane- or dihalogenaryl cross-linking agents (e.g. Hal-(CH₂)ₓ-Hal, x represents a number between 3 and 20) by S-alkylation of the sulfinate group and alkylation of the tertiary basic N-group,
(VI) group c) by reaction with diamines.

11. Membranes according to claim 10, characterized in that as cross-linking reaction the cross-linking reactions (III), (IV) and (V) and especially the cross-linking (III) are preferred.

12. Membranes according to claims 1 to 11, characterized in that the inorganic salt and/or oxide and/or hydroxide, that has been precipitated by a hydrolysis process and/or a precipitation process in the membrane matrix, is selected from:
phosphate and hydrogenphosphate as well as acidic and completely neutralised diphosphates or carbonates of Ti, V, Cr, Mn, Fe, Co, Ni, Cu, Zn, Zr, Nb, Mo, Ce, Ta, W, Sm, Eu, Gd, Yb, La;
oxides and hydroxides resp. water-containing oxides of Ti, V, Cr, Mn, Fe, Co, Ni, Cu, Zn, Zr, Nb, Mo, Ce, Ta, W, Sm, Eu, Gd, Yb, La.

13. Membranes according to claim 12, characterized in that the oxides TiO₂, ZrO₂ and the sparingly soluble metal phosphates Zr₃(PO₄)₄, Ti₃(PO₄)₄, ZrP₂O₇, TiP₂O₇ and zirconhydrogenophosphates as well as titaniumhydrogenophosphates are preferred.

14. Membranes according to claims 1 to 13, characterized in that the hetero polyacid or the polyacid or their alkali metal salts are selected from:
polyphosphoric acid and hetero polyacids such as the phosphortungstenacid hydrate H₃PW₁₂O₄₀x29 H₂O (TPA) and molybdatophosphoric acid hydrate H₃PMo₁₂O₄₀x29 H₂O (MPA) as well as the alkali metal salts of hetero polyacids such as the disodium salt of TPA (Na-TPA).

15. Membranes according to claims 1 to 14, characterized in that the fine if necessary nano-sized salt powder, oxide powder or hydroxide powder, that is added as a powder to the polymer solution is selected from:
water containing particles, carrying OH-groups on their surface, preferably based on Al₂O₃ (bayerite, pseudobohmite, gibbsite=hydrargillite, diaspor, böhmit), as well as vanadium- or tungsten-based oxides (V₂O₅, VOₓ, WOₓ) or alloys from these oxides:

| | | |
|---|---|---|
| Al₂O_{3*}xH₂O | x = 1-10 | |
| V₂O_{5*}xH₂O | x = 1-10 | |
| VO_{x*}yH₂O | y = 1-10 | x = 1.5-3 |
| WO_{x*}yH₂O | y = 1-10 | x = 2-3, |

ion exchanged, especially preferred are protonated alloys of oxides, which form in their original composition the β-aluminate structure, this class of compounds is formed from alloys of the below mentioned oxides, the formulae of composition describe the range, in which the starting compound, the β-aluminate, is formed.
As preferred component Me in Me₂O Na or K is used. The produced, alkali containing compounds have to be ion exchanged before they can be used for the membrane. In doing so the alkali ion is removed and the protonated form is generated.
zMe₂O-xMgO-yAl₂O₃, _{z}Me₂O-xZnO-yAl₂O₃, zMe₂O-xCoO-yAl₂O₃,
zMe₂O-xMnO-yAl₂O₃, zMe₂O-xNiO-yAl₂O₃, zMe₂O-xCrO-yAl₂O₃, zMe₂O-xEuO-yAl₂O₃, zMe₂O-xFeO-yAl₂O₃,
zMe₂O-xSmO-yAl₂O₃
with Me═Na, K, z=0,7-1,2
(with x=0,1-10, y=0,1-10), stable until appr. 300° C.
Other suitable ceramic powders contain the components MgO, ZnO, CoO, MnO, NiO, CrO, EuO, FeO, SmO. Further suitable oxides are based on the elements Ti, V, Cr, Mn, Fe, Co, Ni, Cu, Zn, Zr, Nb, Mo, Ce, Ta, W, Sm, Eu, Gd, Yb, La
Other suitable, in part sparingly soluble metal salts are: phosphates and hydrogenphosphates as well as acidic and entirely neutralised diphosphates of Ti, V, Cr, Mn, Fe, Co, Ni, Cu, Zn, Zr, Nb, Mo, Ce, Ta, W, Sm, Eu, Gd, Yb, La.
Addionally the carbonates are suitable such as e.g. MgCO₃xH₂O and La(CO₃)₂xH₂O as well as oxycarbonates and the proton conducting perowskitic oxides such as e.g. strontium-barium-ceroxide, barium-calcium-niobate etc. as ceramic components.
Also siliciumdioxide in its different modifications is suitable as ceramic component. Especially preferred are highly dispersed siliciumdioxides, e.g. from the Aerosile® group.
Phyllosilicate based on montmorillonite, smectite, illite, sepiolite, palygorskite, muscovite, allevardite, amesite, hectorite, talc, fluorhectorite, saponite, beidelite, nontronite, stevensite, bentonite, mica, vermiculite, fluorvermiculite, halloysite, fluor containing synthetical talc types or blends of two or more of the above-mentioned phyllosilicates.
Natural and synthetical, if necessary ion exchanged zeolithes, especially ZSM-5 zeolith and klinopthiolites

16. Method “Methode I” for the production of membranes according to claims 1 to 15, characterized in that it is composed from the following steps:
I.1. Making of a solution of one or more polymers of the type A (polymer with cation exchange groups or their non-ionic precursors) and if necessary one or more polymers of the type B (polymers with N-basic groups and/or anion exchange groups) and if necessary of type C (polymers with cross-linking groups such as sulfinate groups and/or unsaturated groups) and/or polymeres of the type D (polymers with cation exchange groups or their non-ionic precursors and anion exchange groups and/or basic N-groups and/or cross-linking groups) in a solvent L1 and if necessary a if necessary nano-sized metal oxide powder, metal salt powder or metal hydroxide powder (8);
I.2. Making of a solution of one or more metal salts Me⁺X⁻ (10) in a suitable solvent L2 (11), if necessary by addition of a (hetero)polyacid or their alkali metal salt (9);
I.3. Mixing of solutions from 1. and 2;
I.4. Casting or spraying of a thin film of the mixture of 3. on a support (foil or textile or nonwoven or glass plate or metal plate);
I.5. Evaporation of the solvents L1 and L2 at elevated temperature and if necessary reduced pressure;
I.6. Separation of the composite film from the support;
I.7. Soaking of the composite film in the following liquids:
I.7a aqueous solution of a basic metal hydroxide MOH or an amine or ammonia N(R₂)₃ at temperatures from 0° C. to 100° C., at which precipitation of a sparingly soluble metal oxide MeₘOₙ or metal hydroxide Meₘ(OH)ₙ or mixed metal oxide-hydroxide MeₘOₙ*xH₂O in the membrane matrix takes place;
I.7b aqueous solution of an inorganic acid HY at temperatures from 0° C. to 100° C., which precipitates a sparingly soluble metal salt MeₘYₙ in the membrane matrix;
I.7c water at temperatures from 0° C. to 100° C.,

17. Method “Methode II” for the production of membranes according to claims 1 to 15, characterized in that it is composed from the following steps:
II.1. Making of a solution of one or more polymers of the type A (polymer with cation exchange groups or their non-ionic precursors) and if necessary one or more polymers of the type B (polymers with N-basic groups and/or anion exchange groups) and if necessary of type C (polymers with cross-linking groups such as sulfinate groups and/or unsaturated groups) and/or polymeres of the type D (polymers with cation exchange groups or their non-ionic precursors and anion exchange groups and/or basic N-groups and/or cross-linking groups) and if necessary addition of a cross-linker (e.g. Alkylation cross-linker (e.g. α,ω)-dihalogenalkane)) or radical starter in a solvent L1 and if necessary a if necessary nano-sized metal oxide powder, metal salt powder or metal hydroxide powder and/or a (hetero)polyacid;
II.2. Casting or spraying of a thin film of the mixture of 1. on a support (foil or textile or nonwoven or glass plate or metal plate);
II.3. Evaporation of the solvent L1 at elevated temperature and if necessary reduced pressure; during the solvent evaporation takes place if necessary the cross-linking of the corss-linker;
II.4. Separation of the composite film from the support;
II.5. Soaking of the composite film in the following liquids:
II.5a water or mixture of water with organic solvent L1 at temperatures from 0° C. to 100° C.;
II.5b aqueous solution or solution of one or more metal salts Me⁺ X⁻ or solution of one mor more metal salts Me⁺X⁻ in a mixture of water and organic solvent L2 at temperatures from 0° C. to 100° C.; in doing so ion exchange takes place:
Polymer-R⁻C⁺+Me⁺X⁻→Polymer-R⁻Me⁺+C⁺X⁻
Me⁺ represents any 1- to 4-valent metal cation or metal oxycation, X⁻ represents any ^{a}nion, R⁷ represents any Polymer-Festanion, C⁺ represents any counter ion (any cation)
II.5c water at temperatures from 0° C. to 100° C.;
II.5d aqueous solution of a basic metal hydroxide MOH at temperatures from 0° C. to 100° C., at which precipitation of a sparingly soluble metal oxide MeₘOₙ or metal hydroxide Meₘ(OH)ₙ in the membrane matrix takes place;
II.5e water at temperatures from 0° C. to 100° C.;
II.5f aqueous solution of an inorganic acid HY at temperatures from 0° C. to 100° C., which precipitates a sparingly soluble metal salt MeₘYₙ in the membrane matrix;
II.5g aqueous solution of a metal salt MY at temperatures from 0° C. to 100° C., which precipitates a sparingly soluble metal salt MeₘYₙ by “Umsalzung” in the membrane matrix,
II.5h one-time or several times repetition of the procedure 5a to 5g.

18. Method III for the production of composite membrane films according to claims 1 to 18, characterized in that it is comprised of a combination of “Methode I” and “Methode II” and contains the following steps:
III.1: production of a composite membrane by “Methode I”;
III.2: post-treatment by “Methode II” starting from step II.5

19. Process according to claims 16 to 18, characterized in that the solvent L1 is selected from:
Protic solvents: Water, alcoholes (e.g. methanol, ethanol, npropanol, ipropanol, tert. Butanol);
dipolar-aprotic solvents: acetone, methylethylketone (MEK), acetonitrile (ACN), N methylformamide, N,N-dimethylformamide (DMF), N-methylacetamide, N,N-dimethylacetamide (DMAc), N-methylpyrrolidinone (NMP), dimethylsulfoxide (DMSO), sulfolane;
ether solvents: tetrahydrofurane, oxane, dioxane, glyme, diglyme, triglyme, tetraglyme, diethylether, di-tert. Butylether, especially preferred as solvent L1 are dipolar-aprotic solvents.

20. Process according to claims 16 to 19, characterized in that the metal salt Me⁺X⁻ is selected from:
salts of transition metal cations (e.g. of metals Ti, V, Cr, Mn, Fe, Co, Ni, Cu, Zn, Zr, Sn, Nb, Mo, Ce, Ta, W, Sm, Eu, Gd, Yb, La) or transition metal oxycations such as ZrO²⁺, TiO²⁺, and anions of mineral acids, such as e.g. Hal⁻ (Hal═F, Cl, Br, I) or SO₄²⁻, which are in solvents L2 soluble, as metal salts are especially preferred ZrOCl₂, ZrOSO₄, TiOCl₂, TiOSO₄, ZrCl₄ or TiCl₄.

21. Process according to claims 16 to 20, characterized in that the organic solvent L2 is selected from dipolar-aprotic solvents, especially preferred as solvent are DMSO and sulfolane.

22. Process according to claims 16 to 21, characterized in that the basic metal hydroxide or amine or ammonia is selected from: alkali hydroxides or alkaline earth hydroxides, ammonia, triethylamine or n-alkylamine CₙH₂ₙ₋₁NH₂ with n represents a number between 1 to 20, especially preferred are NaOH, KOH and NH₃.

23. Process according to claims 16 to 22, characterized in that the sparingly soluble metal oxide MeₘOₙ or metal hydroxide Meₘ(OH)ₙ or mixed metal oxide-hydroxide MeₘOₙ*x H₂O precipitated in the membrane matrix is selected from metal oxides, metal hydroxides or metal oxid-hydroxides of the metals Ti, V, Cr, Mn, Fe, Co, Ni, Cu, Zn, Zr, Nb, Mo, Ce, Ta, W, Sm, Eu, Gd, Yb, La, especially preferred are Ti, Zr, Mo and W.

24. Process according to claims 16 to 23, characterized in that the mineral acid HY is selected from: mono-, di- or polyphosphoric acid or heteropolyacids or sulfuric acid, preferred is ortho-phosphoric acid

25. Process according to claims 16 to 24, characterized in that the sparingly soluble metal salt MeₘYₙ is selected from:
orthophosphates, diphosphates, polyphosphates or hydrogenphosphates or sulfates of Ti, V, Cr, Mn, Fe, Co, Ni, Cu, Zn, Zr, Nb, Mo, Ce, Ta, W, Sm, Eu, Gd, Yb, La, Ba.

26. Use of membranes according to claims 1 to 25 to gain energy by electrochemical means.

27. Use of membranes according to claims 1 to 25 as component of membrane fuel cells (hydrogen fuel cells or direct methanol fuel cells) at temperatures from −20° C. to +180° C.

28. Use of membranes according to claims 1 to 25 in electrochemical cells.

29. Use of membranes according to claims 1 to 25 in secondary batteries.

30. Use of membranes according to claims 1 to 25 in electrolysis cells.

31. Use of membranes according to claims 1 to 25 in membrane separation processes such as gas separation, pervaporation, perstraktion, reverse osmosis, elektrodialysis and diffusion dialysis.
